(19) United States
(12) Patent Application Publication
(10) Pub. No.: US 2023/0417892 A1
(43) Pub. Date: Dec. 28, 2023

(54) RADIO FREQUENCY COMMUNICATION METHOD, VEHICLE CONTROL METHOD, DEVICE, SYSTEM, AND STORAGE MEDIUM

(71) Applicant: Alibaba (China) Co., Ltd., Hangzhou (CN)

(72) Inventors: Pengyu Zhang, Bellevue, WA (US); Bo Liang, Beijing (CN); Xue Wang, Beijing (CN); Hongqiang Liu, Bellevue, WA (US)

(73) Assignee: Alibaba (China) Co., Ltd., Hangzhou (CN)

(21) Appl. No.: 18/171,259

(22) Filed: Feb. 17, 2023

(30) Foreign Application Priority Data
Jun. 27, 2022 (CN) 202210743280.X

(51) Int. Cl. G01S 13/26

(52) U.S. Cl. CPC G01S 13/26

(57) ABSTRACT

A radio frequency communication method, a vehicle control method, a device, and a system are provided. The radio frequency communication method includes: acquiring a first response signal and a second response signal which are corresponding to a radio frequency tag, wherein the first response signal and the second response signal are respectively generated by the radio frequency tag responding to radio frequency signals of different powers; determining, based on the second response signal, positioning information of the radio frequency tag; and establishing, based on the positioning information and the first response signal, a communication connection to the radio frequency tag.

The present application claims priority to Chinese patent application No. 202210743280.X, filed with the Chinese Patent Office on Jun. 27, 2022 and entitled “RADIO FREQUENCY COMMUNICATION METHOD, VEHICLE CONTROL METHOD, DEVICE, AND SYSTEM”, which is incorporated herein by reference in its entirety.

### TECHNICAL FIELD

The present application relates to the field of radio frequency technology, and in particular to a radio frequency communication method, a vehicle control method, a device, and a system.

### BACKGROUND

Radio-Frequency IDentification (abbreviated as RFID) is a technology that identifies a target object by a radio frequency signal and reads and writes related data. Because RFID tags do not rely on a battery to work, it is convenient to use and the production cost is low, which have been widely adopted in areas such as identity document, access control, logistics, asset management, etc.

During the actual production, use and deployment, in a case where a RFID system reads a RFID tag in a target area (the RFID tag which the RFID system wants to read), there is often a RFID tag in a non-target area (the RFID tag which the RFID system does not want to read) around. The tradition RFID system may realize “reading all target tags” and “avoiding reading any non-target tags” by controlling reading power, but in actual scenarios, this kind of control is difficult. Specifically, when the reading power is too high, a non-target RFID tag in another area is easily read (error-reading); and when the reading power is too low, a target tag in this area may be missed (miss-reading).

It can be seen from above that the current RFID system cannot control a scanning area accurately, so there are common miss-reading and error-reading problems, which hinders the large-scale deployment and use of the RFID system greatly.

### SUMMARY

The embodiments of the present application provide a radio frequency communication method, a vehicle control method, a device, and a system, which realize that a positioning operation and a communication operation for radio frequency tags are separated from each other, and can effectively avoid the situation of miss-reading and error-reading of the radio frequency tags.

In a first aspect, an embodiment of the present application provides a radio frequency communication method, including: acquiring a first response signal and a second response signal which are corresponding to a radio frequency tag, wherein the first response signal and the second response signal are respectively generated by the radio frequency tag responding to radio frequency signals of different powers; determining, based on the second response signal, positioning information of the radio frequency tag; and establishing, based on the positioning information and the first response signal, a communication connection to the radio frequency tag.

In a second aspect, an embodiment of the present application provides a radio frequency communication apparatus, including: a first acquiring module, configured for acquiring a first response signal and a second response signal which are corresponding to a radio frequency tag, wherein the first response signal and the second response signal are respectively generated by the radio frequency tag responding to radio frequency signals of different powers; a first determining module, configured for determining, based on the second response signal, positioning information of the radio frequency tag; and a first communication module, configured for establishing, based on the positioning information and the first response signal, a communication connection to the radio frequency tag.

In a third aspect, an embodiment of the present application provides an electronic device, including: a memory and a processor; wherein the memory is configured for storing one or more computer instructions that, when executed by the processor, implement the radio frequency communication method indicated in the first aspect.

In a fourth aspect, an embodiment of the present application provides a computer storage medium for storing a computer program that, when executed by a processor, causes the computer to implement the radio frequency communication method indicated in the first aspect.

In a fifth aspect, an embodiment of the present application provides a computer program product, including: a computer program that, when executed by a processor of an electronic device, causes the processor to perform steps of the radio frequency communication method indicated in the first aspect.

In a sixth aspect, an embodiment of the present application provides a vehicle control method, including: acquiring a first response signal and a second response signal, which are corresponding to a radio frequency tag in a vehicle to be controlled, wherein the first response signal and the second response signal are respectively generated by the radio frequency tag responding to radio frequency signals of different powers; determining, based on the second response signal, positioning information of the vehicle to be controlled; generating, based on the positioning information and the first response signal, control information corresponding to the vehicle to be controlled; and controlling, based on the control information, the vehicle to be controlled.

In a seventh aspect, an embodiment of the present application provides a vehicle control apparatus, including: a second acquiring module, configured for acquiring a first response signal and a second response signal, which are corresponding to a radio frequency tag in a vehicle to be controlled, wherein the first response signal and the second response signal are respectively generated by the radio frequency tag responding to radio frequency signals of different powers; a second determining module, configured for determining, based on the second response signal, positioning information of the vehicle to be controlled; a second generating module, configured for generating, based on the positioning information and the first response signal, control information corresponding to the vehicle to be controlled; and a second control module, configured for controlling, based on the control information, the vehicle to be controlled.

In an eighth aspect, an embodiment of the present application provides an electronic device, including: a memory and a processor; wherein the memory is configured for storing one or more computer instructions that, when executed by the processor, implement the vehicle control method indicated in the sixth aspect.

In a ninth aspect, an embodiment of the present application provides a computer storage medium for storing a computer program that, when executed by a computer, causes the computer to implement the vehicle control method indicated in the sixth aspect.

In a tenth aspect, an embodiment of the present application provides a computer program product, including: a computer program that, when executed by a processor of an electronic device, cause the processor to perform steps of the vehicle control method indicated in the sixth aspect.

In an eleventh aspect, an embodiment of the present application provides a radio frequency communication method, including: acquiring a first response signal and a second response signal which are corresponding to a radio frequency tag in an extended reality terminal, wherein the first response signal and the second response signal are respectively generated by the radio frequency tag responding to radio frequency signals of different powers; determining, based on the second response signal, positioning information of the extended reality terminal; and establishing, based on the positioning information and the first response signal, a communication connection to the extended reality terminal.

In a twelfth aspect, an embodiment of the present application provides a radio frequency communication apparatus, including: a third acquiring module, configured for acquiring a first response signal and a second response signal which are corresponding to a radio frequency tag in an extended reality terminal, wherein the first response signal and the second response signal are respectively generated by the radio frequency tag responding to radio frequency signals of different powers; a third determining module, configured for determining, based on the second response signal, positioning information of the extended reality terminal; and a third communication module, configured for establishing, based on the positioning information and the first response signal, a communication connection to the extended reality terminal.

In a thirteenth aspect, an embodiment of the present application provides an electronic device, including: a memory and a processor; wherein the memory is configured for storing one or more computer instructions that, when executed by the processor, implement the radio frequency communication method indicated in the eleventh aspect.

In a fourteenth aspect, an embodiment of the present application provides a computer storage medium for storing a computer program that, when executed by a computer, causes the computer to implement the radio frequency communication method indicated in the eleventh aspect.

In a fifteenth aspect, an embodiment of the present application provides a computer program product, including: a computer program that, when executed by a processor of an electronic device, causes the processor to perform steps of the radio frequency communication method indicated in the eleventh aspect.

In a sixteenth aspect, an embodiment of the present application provides a radio frequency communication system, including: a demodulating device, configured for acquiring a first response signal and a second response signal which are corresponding to a radio frequency tag, wherein the first response signal and the second response signal are respectively generated by the radio frequency tag responding to radio frequency signals of different powers; a positioning device, configured for determining, based on the second response signal, positioning information of the radio frequency tag; and a communication device, configured for establishing, based on the positioning information and the first response signal, a communication connection to the radio frequency tag.

According to the radio frequency communication method, the vehicle control method, the device, and the system provided by the embodiments of the present application, the radio frequency tag is positioned by the second response signal, and the communication operation with the positioned radio frequency tag is performed by the first response signal, which effectively realizes that the positioning operation and the communication operation for the radio frequency tag are separated from each other. That is, the communication method realizes a sniffing system architecture in which the communication and positioning for the radio frequency tag are separated from each other. This can not only improve the quality and efficiency of the communication with the radio frequency tag, but also avoid the problems of miss-reading and error-reading of the radio frequency tag, thereby effectively guaranteeing the practicability of the radio frequency communication method, and facilitating the large-scale deployment and use of the radio frequency communication method.

### BRIEF DESCRIPTION OF THE DRAWINGS

In order to illustrate technical solutions in the present application or in the prior art more clearly, the accompanying drawings required to be used in the descriptions of the embodiments or the prior art will be simply described. Obviously, the accompanying drawings in the following description are some embodiments of the present application. For those skilled in the art, other drawings may be obtained in accordance with these drawings without creative efforts.

FIG. 1 is a schematic scenario diagram of a radio frequency communication method provided by an embodiment of the present application;

FIG. 2 is a schematic flow chart of a radio frequency communication method provided by an embodiment of the present application;

FIG. 3 is a schematic flow chart of acquiring a first response signal corresponding to a radio frequency tag provided by an embodiment of the present application;

FIG. 4 is a schematic diagram of acquiring a first response signal and a second response signal corresponding to a radio frequency tag provided by an embodiment of the present application;

FIG. 5 is a schematic flow chart of determining, based on the second response signal, positioning information of the radio frequency tag provided by an embodiment of the present application;

FIG. 6 is a schematic flow chart of another radio frequency communication method provided by an embodiment of the present application;

FIG. 7 is a schematic flow chart of determining, based on phase information corresponding to respective frequency point of multiple frequency points and area information, positioning information of a radio frequency tag provided by an embodiment of the present application;

FIG. 8 is a schematic principle diagram of a radio frequency communication method provided by an application embodiment of the present application;

FIG. 9 is a schematic principle diagram of determining, based on channel estimation information, positioning information of a radio frequency tag provided by an application embodiment of the present application;

FIG. 10 is a schematic flow chart of a vehicle control method provided by an embodiment of the present application;

FIG. 11 is a schematic flow chart of a radio frequency communication method provided by an embodiment of the present application;

FIG. 12 is a schematic structural diagram of a radio frequency communication apparatus provided by an embodiment of the present application;

FIG. 13 is a schematic structural diagram of an electronic device corresponding to the radio frequency communication apparatus shown in FIG. 12;

FIG. 14 is a schematic structural diagram of a vehicle control apparatus provided by an embodiment of the present application;

FIG. 15 is a schematic structural diagram of an electronic device corresponding to the vehicle control apparatus shown in FIG. 14;

FIG. 16 is a schematic structural diagram of a radio frequency communication apparatus provided by an embodiment of the present application;

FIG. 17 is a schematic structural diagram of an electronic device corresponding to the radio frequency communication apparatus shown in FIG. 16; and

FIG. 18 is a schematic structural diagram of a radio frequency communication system provided by an embodiment of the present application.

### DETAILED DESCRIPTION

In order to make the objectives, technical solutions and advantages of the embodiments of the present application clearer, the technical solutions in the embodiments of the present application will be clearly and completely described below with reference to the accompanying drawings in the embodiments of the present application. Apparently, the described embodiments are some of, rather than all of, the embodiments of the present application. All other embodiments obtained by those of ordinary skill in the art based on the embodiments of the present application without any inventive efforts shall fall within the scope of protection of the present application.

Terms used in the embodiments of the present application are merely for the purpose of describing specific embodiments, and are not intended to limit the present application. The singular forms “a,” “the” and “this” used in the embodiments and appended claims of the present application are also intended to include the plural forms thereof. Unless otherwise clearly noted in the context, “a plurality of” generally includes at least two, but including at least one should not be excluded.

It should be appreciated that the term “and/or” used herein is merely an association relationship describing associated objects, indicating that there may be three relations. For example, A and/or B may indicate the following three cases: A exists individually, A and B exist simultaneously, and B exists individually. In addition, the character “/” herein generally indicates that the associated objects before and after the character form an “or” relation.

Depending on the context, the term “if” or “in a case where” as used herein may be interpreted as “when,” or “in the case that,” or “in response to determining,” or “in response to detecting.” Similarly, depending on the context, the phrase “if it is determined that” or “if it is detected that (a stated condition or event)” may be interpreted as “when it is determined that” or “in response to determining,” or “when detecting (a stated condition or event)” or “in response to detecting (a stated condition or event)”.

It should also be noted that the term “comprise,” “include,” or any other variant thereof is intended to encompass a non-exclusive inclusion, so that a product or system that involves a series of elements includes not only those elements, but also other elements not explicitly listed, or elements that are inherent to such a product or system. Without more restrictions, an element defined by the phrase “comprising one . . . ” does not exclude the presence of another same element in the product or system that includes the element.

In addition, the sequence of steps in the following method embodiments is only an example and is not to impose a strict limitation.

### DEFINITION OF TERMS

Radio-Frequency IDentification (abbreviated as RFID): the technology of activating a RFID tag contactles sly and remotely by a wireless signal, and reading its ID.
Sniffer: the technology of separating communication and positioning, communicating by using an ISM frequency band, and completing position estimation through a wider frequency band.
RF Hologram: the technology of performing holographic imaging by using radio frequency signal intensity and phase information.
Beamforming: the technology of transmitting and receiving by using multiple antenna arrays to narrow the beam width of a wireless signal.
Transmitter (abbreviated as TX): used for transmitting data.
Receiver (abbreviated as RX): used for receiving data.
EPC GEN II: a global uniform standard of Ultra High Frequency (abbreviated as UHF) RFID.
Preamble: according to the regulation of the RFID communication protocol, the response of a RFID tag will transmit a preamble firstly, which is convenient for a reader to perform demodulation and frequency offset estimation.
Viterbi: a dynamic programming algorithm, used for demodulating.
M4: an encoding scheme regulated by the RFID protocol, which may complete a correct demodulation operation in the case of inaccurate time synchronization.
Jump of it: in the process of demodulating the received signal, there may be a half-period error in start time estimate, the demodulation may be performed correctly due to the error-tolerance mechanism of M4 encoding, but correct channel estimation information cannot be given.

In order to facilitate those skilled in the art to understand the technical solution provided by the embodiments of the present application, relevant technologies will be explained below. At present, for the RFID system, the identification performance bottleneck of a radio frequency tag is the accuracy of reading a RFID tag. During the actual use and deployment, in a case where a RFID system reads a RFID tag in a target area (the RFID tag which the RFID system wants to read), there is often a RFID tag in a non-target area (the RFID tag which the RFID system does not want to read) around. The tradition RFID system may realize “reading all target tags” and “avoiding reading any non-target tags” by controlling reading power, but in actual scenarios, this kind of control is difficult. Specifically, when the reading power is too high, a non-target RFID tag in another area is easily read (error-reading); and when the reading power is too low, a target tag in this area may be missed (miss-reading).

It can be seen from above that the current RFID system cannot accurately control a scanning area, so there are common miss-reading and error-reading problems, which is the core reason that hinders the large-scale deployment and use of the RFID system. In order to solve the foregoing two technical problems, RFID tags may be attached with positioning ability. However, due to the limited spectrum resources used by the RFID, the multipath effect in the indoor environment has a great impact on a positioning result. The median of traditional positioning precision is only meter level and a long tail error is large, so it is difficult to match the requirements of actual deployment.

The first relevant technology provides a RFID positioning technology based on synthetic aperture radar. Specifically, because the utilized bandwidth of the RFID technology is limited and the distance resolution of a positioning system is limited, increasing antenna aperture and the number of antennas may improve angle resolution, thereby making up for overall resolution. However, due to the limit of the size and deployment space of an antenna, the cost of directly using multiple antennas to construct an array is high, while the RFID technology based on synthetic aperture radar stimulates an array of multiple antennas by using mobile antennas, thereby realizing multi-position sampling by using fewer hardware resources, which can effectively improve positioning precision. However, there are three disadvantages: (1) a better synchronous operation between a mechanical motion unit and an information processing unit is required, so the cost of calibration work is high; (2) an antenna needs to move for a long time to complete multi-position information collection, the delay of positioning is large, and the RFID positioning requirements that can be processed per unit time are few; and (3) distance resolution is poor, which may cause a positioning error because of multipath.

The second relevant technology provides a RFID positioning technology based on techniques such as frequency hopping, Orthogonal Frequency Division Multiplexing (abbreviated as OFDM), Frequency Modulated Continuous Wave (abbreviated as FMCW), etc., and the scheme uses wideband RFID to complete positioning, which may effectively improve distance resolution, thereby improving positioning precision. However, the foregoing implementation has the following disadvantages: (1) a frequency hopping technology is used to collect channel information between different frequency bands, to complete bandwidth estimation, which is flexible and average transmit power is low; a single frequency hopping needs a long time to complete the channel information collection for a single tag, and the delay of positioning is large; (2) wideband sampling is performed by using a wideband OFDM carrier; the OFDM carrier is mixed with a multi-tone signal, the signal-to-noise ratio in a demodulation process is low, and the working distance is short; and (3) FMCW is used to scan a wideband for positioning; using FMCW to scan the wideband may obtain complete wideband positioning, but only single channel information may be obtained and it is easy to be affected by other signals on the frequency band, and the final channel estimation precision is poor, which affects the positioning precision.

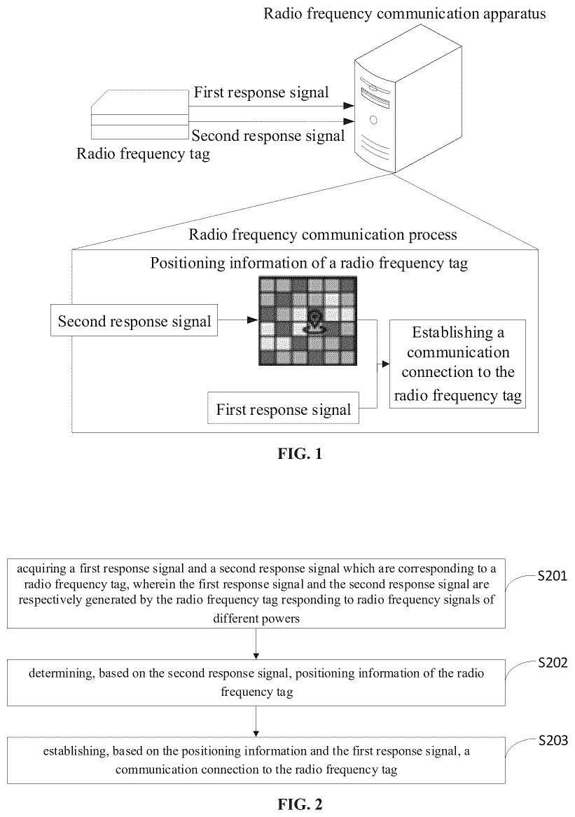

In order to solve the foregoing technical problems, the embodiments of the present application provide a radio frequency communication method, a vehicle control method, a device, and a system. The execution body of the radio frequency communication method may be a radio frequency communication apparatus, specifically, refer to FIG. 1.

The radio frequency communication apparatus may refer to any computing device with certain radio frequency tag identification and communication capabilities. In a specific implementation, the radio frequency communication apparatus may be implemented as a mobile phone, a tablet, a set application program, a robot, a cluster server, a conventional server, a cloud server, a cloud host, a virtual center, etc. In addition, the basic structure of the radio frequency communication apparatus may include at least one processor. The number of processors depends on the configuration and type of a requester. The radio frequency communication apparatus may include a memory, and the memory may be volatile, such as RAM, or may also be nonvolatile, such as Read-Only Memory (abbreviated as ROM), flash memory, etc., or may include the two types at the same time. The memory usually stores an Operating System (abbreviated as OS), and one or more application programs, and it may also store program data, etc. In addition to the processing unit and the memory, the radio frequency communication apparatus further includes some basic configurations, such as a network card chip, an IO bus, a display component, some peripheral devices, etc. Optionally, some peripheral devices may include, for example, keyboards, mouses, input pens, printers, etc. Other peripheral devices are well known in the field and will not be elaborated herein.

In an embodiment of the present application, the radio frequency communication apparatus is configured for acquiring a first response signal and a second response signal which are corresponding to a radio frequency tag (one or more), wherein the first response signal and the second response signal are respectively generated by the radio frequency tag responding to radio frequency signals of different powers; then determining, based on the second response signal, positioning information of the radio frequency tag; and establishing, based on the positioning information and the first response signal, a communication connection to the radio frequency tag.

In the technical solution provided by this embodiment, the radio frequency tag is positioned by the second response signal, and the communication operation with the positioned radio frequency tag is performed by the first response signal, which effectively realizes that the positioning operation and the communication operation for the radio frequency tag are separated from each other. That is, the communication method realizes a sniffing system architecture in which the communication and the positioning for the radio frequency tag are separated from each other. This can not only improve the quality and efficiency of the communication with the radio frequency tag, but also avoid the problems of miss-reading and error-reading of the radio frequency tag, thereby effectively guaranteeing the practicability of the radio frequency communication method, and facilitating the large-scale deployment and use of the radio frequency communication method.

The radio frequency communication method, the vehicle control method, the device, and the system provided by various embodiments of the present application are specifically described below through an exemplary application scenario. Provided that there is no conflict between the embodiments, the following embodiments and features in the embodiments may be combined with each other.

FIG. 2 is a schematic flow chart of a radio frequency communication method provided by an embodiment of the present application. This embodiment provides a radio frequency communication method with reference to FIG. 2. The execution body of the method may be a radio frequency communication apparatus, and the radio frequency communication apparatus may be implemented in software, or a combination of software and hardware. Specifically, the radio frequency communication method may include:
Step S201: acquiring a first response signal and a second response signal which are corresponding to a radio frequency tag, wherein the first response signal and the second response signal are respectively generated by the radio frequency tag responding to radio frequency signals of different powers.
Step S202: determining, based on the second response signal, positioning information of the radio frequency tag.
Step S203: establishing, based on the positioning information and the first response signal, a communication connection to the radio frequency tag.

The implementation process of the foregoing each step is described in detail below:
Step S201: acquiring a first response signal and a second response signal which are corresponding to a radio frequency tag, wherein the first response signal and the second response signal are respectively generated by the radio frequency tag responding to radio frequency signals of different powers.

In order to accurately realize that a radio frequency communication apparatus performs a stable communication connection operation with a radio frequency tag, the radio frequency communication apparatus may acquire the first response signal and the second response signal which are corresponding to the radio frequency tag, wherein the first response signal and the second response signal are respectively generated by the radio frequency tag responding to radio frequency signals of different powers. Specifically, specific implementations of acquiring a first response signal and a second response signal which are corresponding to a radio frequency tag are not limited by this embodiment. In some embodiments, the first response signal and the second response signal which are corresponding to the radio frequency tag may be signals which are generated in advance and stored in a preset area or a preset device. At this time, the acquiring the first response signal and the second response signal which are corresponding to the radio frequency tag may include: determining the preset area or the preset device for storing the first response signal and the second response signal which are corresponding to the radio frequency tag; and acquiring, by accessing the preset area or the preset device, the first response signal and the second response signal which are corresponding to the radio frequency tag.

In some other embodiments, the first response signal and the second response signal which are corresponding to the radio frequency tag may be signals generated in real time. At this time, the acquiring the first response signal and the second response signal which are corresponding to the radio frequency tag may include: the radio frequency communication apparatus may transmit, in real time, radio frequency signals of different powers to the radio frequency tag in the space where the radio frequency communication apparatus is located, and the space may include a two-dimensional space or a three-dimensional space, etc. The radio frequency tag in the space may respond to the radio frequency signals of different powers, and generate the first response signal and the second response signal. After generating the first response signal and the second response signal, the radio frequency tag may transmit the first response signal and the second response signal to the radio frequency communication apparatus, so that the radio frequency communication apparatus may stably acquire the first response signal and the second response signal which are corresponding to the radio frequency tag.

When the radio frequency signals of different powers include the first radio frequency signal and the second radio frequency signal, the first response signal may be generated by responding to the first radio frequency signal, and the second response signal may be generated by responding to the second radio frequency signal. It should be noted that the power of the first radio frequency signal may be greater than the power of the second radio frequency signal. In some embodiments, the power of the first radio frequency signal may be far greater than the power of the second radio frequency signal, at this time, the power of the first radio frequency signal may be greater than or equal to a first preset threshold, the power of the second radio frequency signal may be less than a second preset threshold, and the second preset threshold is less than the first preset threshold. In some other embodiments, the power of the first radio frequency signal may be greater than the power of the second radio frequency signal, at this time, both the power of the first radio frequency signal and the power of the second radio frequency signal may be greater than or equal to the first preset threshold, thereby effectively realizing that the radio frequency tag can generate, by responding to the radio frequency signals of different powers, the first response signal and the second response signal, and enabling the radio frequency communication apparatus to stably acquire the first response signal and the second response signal.

Step S202: determining, based on the second response signal, positioning information of the radio frequency tag.

Because the second response signal usually includes information such as signal transmission time, signal transmission phase, etc., and the signal transmission time and the signal transmission phase are related to positioning information of the radio frequency tag, after acquiring the second response signal, in order to accurately perform a positioning operation on the radio frequency tag, the second response signal may be processed to determine the positioning information of the radio frequency tag, and the positioning information is used for identifying the position of the radio frequency signal in the preset space/preset area.

Specifically, specific implementations of determining the positioning information of the radio frequency tag are not limited by this embodiment. In some embodiments, the determining, based on the second response signal, the positioning information of the radio frequency tag may include: acquiring a machine learning model or a preset algorithm used for processing the second response signal, and processing the second response signal by using the machine learning model or the preset algorithm, to obtain the positioning information of the radio frequency tag. In some other embodiments, the determining, based on the second response signal, the positioning information of the radio frequency tag may include: determining signal transmission time and signal transmission phase which are corresponding to the second response signal; determining, based on the signal transmission time, light speed information and the signal transmission phase, the positioning information of the radio frequency tag, thereby guaranteeing the accuracy and reliability of determining the positioning information of the radio frequency tag.

In some other embodiments, before determining, based on the second response signal, the positioning information of the radio frequency tag, the method of this embodiment may further include: acquiring a preset power signal included in the second response signal, wherein a power of the preset power signal is greater than or equal to a preset power threshold; and performing, by using a band-stop filter, filtering processing on the preset power signal included in the second response signal, to obtain the processed response signal.

Because the second response signal is a preset signal of a lower power, in the process of transmitting the second response signal, there may be a noise signal or other clutter signals (corresponding to a high-power component) in the received second response signal. In order to avoid the noise signal or other clutter signals having an impact on the processing operation of the second response signal, before the positioning operation of the radio frequency tag is performed based on the second response signal, the high-power component included in the second response signal may be filtered by using the band-stop filter. Specifically, after the second response signal is acquired, the preset power signal included in the second response signal may be identified firstly, because the power of the preset power signal is greater than or equal to the preset power threshold, it means that the preset power signal is the high-power component included in the second response signal. The foregoing high-power component is usually a noise signal or other clutter signals, and then filtering processing may be performed on the preset power signal by using the band-stop filter, so that the processed response signal may be obtained. Thus, when processing is performed based on the processed response signal, the accuracy and reliability of determining the positioning information of the radio frequency tag may be guaranteed effectively.

Step S203: establishing, based on the positioning information and the first response signal, a communication connection to the radio frequency tag.

After the positioning information of the radio frequency tag is acquired, the radio frequency communication apparatus can accurately perform a positioning operation on the radio frequency tag to be communicated, and may then establish a communication connection to the radio frequency tag based on the positioning information and the first response signal, thereby effectively realizing performing, based on the second response signal, the positioning operation on the radio frequency tag. Then, a communication connection to the positioned radio frequency tag may be established based on the first response signal. That is, the separation of the positioning operation and the communication operation for the radio frequency tag is realized, which is conducive to improve the stability and reliability of establishing the communication connection between the radio frequency communication apparatus and the radio frequency tag.

According to the radio frequency communication method provided by the embodiments of the present application, by acquiring the first response signal and the second response signal which are corresponding to the radio frequency tag, the positioning information of the radio frequency tag is determined based on the second response signal, and the communication connection to the radio frequency tag is established based on the positioning information and the first response signal, which effectively realizes that the positioning operation and the communication operation for the radio frequency tag are separated from each other. That is, the communication method realizes a sniffing system architecture in which the communication and the positioning for the radio frequency tag are separated from each other. This can not only improve the quality and efficiency of communication with the radio frequency tag, but also avoid the problems of miss-reading and error-reading for the radio frequency tag, thereby effectively guaranteeing the practicability of the radio frequency communication method, and facilitating the large-scale deployment and use of the radio frequency communication method.

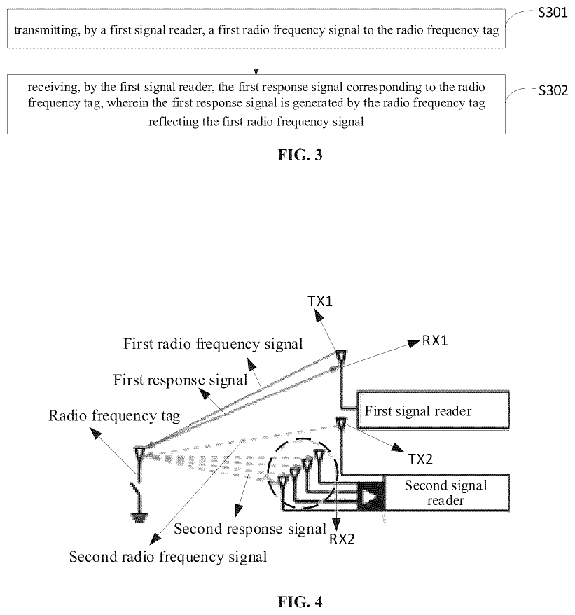

FIG. 3 is a schematic flow chart of acquiring a first response signal corresponding to a radio frequency tag provided by an embodiment of the present application. On the basis of the foregoing embodiment, with reference to FIG. 3, because the first response signal and the second response signal are respectively generated by the radio frequency tag responding to radio frequency signals of different powers, at this time, an implementation of acquiring the first response signal and the second response signal which are corresponding to the radio frequency tag may be: transmitting radio frequency signals of different powers to the radio frequency tag asynchronously by a unified signal reader, for example, transmitting a first radio frequency signal firstly, after the first response signal is acquired, transmitting a second radio frequency signal, then obtaining the second response signal; or, transmitting a first radio frequency signal and a second radio frequency signal successively, then receiving the first response signal and the second response signal successively by the unified signal reader. However, not only there is a time difference for the first response signal and the second response signal acquired by the foregoing implementation, but also there may also be signal interference in the first response signal and the second response signal. Therefore, in order to guarantee the accuracy and reliability of acquiring the first response signal and the second response signal, the radio frequency signals of different powers may be transmitted to the radio frequency tag respectively by different signal readers. At this time, the acquiring the first response signal corresponding to the radio frequency tag may include:
Step S301: transmitting, by a first signal reader, a first radio frequency signal to the radio frequency tag.
Step S302: receiving, by the first signal reader, the first response signal corresponding to the radio frequency tag, wherein the first response signal is generated by the radio frequency tag reflecting the first radio frequency signal.

Herein, the radio frequency communication apparatus (hereinafter simply referred to as the communication apparatus) may include the first signal reader, or, the communication apparatus may be connected to the first signal reader. Then, in order to acquire the first response signal accurately, the first radio frequency signal may be may transmitted to the radio frequency tag by the first signal reader, and the first radio frequency signal may be a conventional ISM frequency band signal. After the radio frequency tag acquires the first radio frequency signal, the reflection coefficient stored in the radio frequency tag will change, so that the radio frequency tag may reflect the first radio frequency signal and generate the first response signal. After generating the first response signal, the radio frequency tag may return the generated first response signal, at this time, the first response signal corresponding to the radio frequency tag may be received by the first signal reader.

Similarly, the acquiring a second response signal corresponding to the radio frequency tag may include:
Step S301: transmitting, by a second signal reader, a second radio frequency signal to the radio frequency tag, wherein a power of the second radio frequency signal is less than a power of the first radio frequency signal, and the power of the second radio frequency signal is less than or equal to a preset threshold.
Step S302: acquiring, by the second signal reader, the second response signal corresponding to the radio frequency tag, wherein the second response signal is generated by the radio frequency tag reflecting the second radio frequency signal.

Herein, the communication apparatus may include the second signal reader, or, the communication apparatus may be connected to the second signal reader. Then, in order to acquire the second response signal accurately, the second radio frequency signal may be transmitted to the radio frequency tag by the second signal reader. It is noted that the power of the second radio frequency signal is less than the power of the first radio frequency signal, and in order to satisfy the requirements of a relevant industry, the power of the second radio frequency signal may be less than or equal to a preset threshold. The foregoing preset threshold is a smaller limiting value for limiting the power of a signal, which may specifically be −20DBM, −25DBM, −30DBM or −35DBM, etc. Specifically, those skilled in the art may configure the preset threshold as any numerical value in the range [−35DBM, −20DBM] according to design requirements and application requirements.

After the radio frequency tag acquires the second radio frequency signal, because the power of the second radio frequency signal is lower and cannot activate the radio frequency tag, but the reflection coefficient in the radio frequency tag may also change, thereby reflecting the second radio frequency signal and generating the second response signal. After the radio frequency tag generates the second response signal, the radio frequency tag may return the generated second response signal. At this time, the second response signal corresponding to the radio frequency tag may be received by the second signal reader.

It is noted that the process of “acquiring the second response signal corresponding to the radio frequency tag” and the process of “acquiring the first response signal corresponding to the radio frequency tag” in this embodiment are two completely independent processes, which may be performed simultaneously, or may also be performed asynchronously.

In addition, because the second response signal is used for performing the positioning operation on the radio frequency tag, in order to accurately perform the positioning operation on the radio frequency tag, the second radio frequency signal in this embodiment may include sine carrier signals of a preset number. The preset number may be greater than or equal to 4. Specifically, the number of sine carrier signals may be 8, 16 or 2. At this time, in order to accurately transmit the second radio frequency signal to the radio frequency tag, the transmitting, by the second signal reader, the second radio frequency signal to the radio frequency tag in this embodiment may include: generating, by the second signal reader, multiple narrowband subcarriers of different frequencies; and integrating the multiple narrowband subcarriers of different frequencies, to obtain the second radio frequency signal.

Specifically, in order to realize transmitting multiple carrier signals to the radio frequency tag, the multiple narrowband subcarriers of different frequencies may be generated firstly by the second signal reader. In some embodiments, the generating, by the second signal reader, the multiple narrowband subcarriers of different frequencies may include: acquiring a preset wideband range by the second signal reader, then determining quantity information N of the narrowband subcarriers, finally, in the wideband range, selecting narrowband subcarriers satisfying the quantity information N. For example, in a case where the wideband range is between 800 MHz and 1000 MHz, because most of the wideband range is used, in order to guarantee the forward processing operation of other data, a certain number of narrowband subcarriers may be extracted in the wideband range. For example, when N is 16, 16 narrowband subcarriers may be selected in the foregoing wideband range. It is noted that, the narrowband subcarrier refers to a carrier whose ratio of signal bandwidth to center does not exceed 10%, or a relatively narrow carrier.

After multiple narrowband subcarriers of different frequencies are acquired, the multiple narrowband subcarriers of different frequencies may be integrated to obtain the second radio frequency signal. In some embodiments, the integrating the multiple narrowband subcarriers of different frequencies to obtain the second radio frequency signal may include: performing splicing processing on all the narrowband subcarriers, to generate the second radio frequency signal. Therefore, the reliability and accuracy of generating the second radio frequency signal is effectively guaranteed.

For example, taking the communication apparatus including the first signal reader and the second signal reader as an example, with reference to FIG. 4, the first signal reader may include a signal transmitter TX1 and a signal receiver RX1. TX1 may transmit the first radio frequency signal to the radio frequency tag, and the reflection coefficient in the radio frequency tag changes, to reflect the first radio frequency signal and generate the first response signal, and the first response signal is returned to the first signal reader. At this time, RX1 in the first signal reader may receive the first response signal. Similarly, the second signal reader may include a signal transmitter TX2 and multiple signal receivers RX2. TX2 may transmit the second radio frequency signal to the radio frequency tag, and the second radio frequency signal may contain multiple sine narrowband subcarriers. The reflection coefficient in the radio frequency tag changes, to reflect the second radio frequency signal and generate the second response signal, and the second response signal contains response signals corresponding to each of the multiple narrowband subcarriers. The second response signal is returned to the second signal reader. At this time, the multiple RX2 in the second signal reader may receive the second response signal including multiple response signals, thereby effectively guaranteeing the reliability and accuracy of acquiring the first response signal and the second response signal.

In this embodiment, the first radio frequency signal and the second radio frequency signal are transmitted to the radio frequency tag respectively by the first signal reader and the second signal reader, and the first response signal and the second response signal which are corresponding to the radio frequency tag are received respectively by the first signal reader and the second signal reader. Because the acquiring operation for the first response signal and the acquiring operation for the second response signal are two independent operations, the reliability and accuracy of acquiring the first response signal and the second response signal are effectively guaranteed, and the quality and effect of performing positioning on the radio frequency tag and communicating with the radio frequency tag are further improved.

FIG. 5 is a schematic flow chart of determining, based on a second response signal, positioning information of a radio frequency tag provided by an embodiment of the present application. On the basis of the foregoing embodiments, with reference to FIG. 5, this embodiment provides an implementation of acquiring channel estimation information through the second response signal, and then determining positioning information of the radio frequency tag based on the channel estimation information. Specifically, the determining, based on the second response signal, the positioning information of the radio frequency tag in this embodiment may include:
Step S501: acquiring area information corresponding to the radio frequency tag.

Herein, the area information refers to any area where the radio frequency tag may appear or all areas which can be covered by a detecting signal of the communication apparatus. Specifically, the area information may be two-dimensional area information or three-dimensional area information, etc. In some embodiments, when the area information refers to any area where the radio frequency tag may appear, the area information may be configured by a user in advance or configured by a user in real time based on requirements. In some other embodiments, when the area information refers to all areas which can be covered by the detecting signal of the communication apparatus, the area information corresponding to the radio frequency tag may be determined by position information of the communication apparatus. At this time, the acquiring the area information corresponding to the radio frequency tag may include: determining position information of the communication apparatus, wherein the position information may be information configured or input in advance by a user, or, the communication apparatus may include a GPS positioning apparatus, and the position information of the communication apparatus may be acquired by the GPS positioning apparatus. After the position information of the communication apparatus is determined, the information of the area where the radio frequency tag is located may be determined based on the position information. For example, a circular area or a spherical area whose center is the positioning information and whose radius is a preset size may be determined as the area information corresponding to the radio frequency tag. The foregoing preset size may be 20 meters, 30 meters or 50 meters, etc., thereby effectively guaranteeing the reliability and accuracy of acquiring the area information where the radio frequency tag is located.

Step S502: performing channelization processing on the second response signal, to obtain digital sampling information corresponding to respective frequency point of multiple frequency points.

In terms of the second response signal, the second response signal contains some noise or clutter information, because the second response signal is used for determining the positioning information of the radio frequency tag, in order to improve the reliability and accuracy of determining the positioning information of the radio frequency tag, channelization processing may be performed on the second response signal, so that digital sampling information corresponding to respective frequency point of the multiple frequency points may be obtained. For example, when the second response signal includes 16 sine narrowband subcarriers, after the channelization processing is performed on the second response signal, the digital sampling information corresponding to each of 16 sine narrowband subcarriers may be acquired, and the digital sampling information does not include noise or clutter information.

In addition, specific implementations of performing the channelization processing on the second response signal are not limited by this embodiment. In some embodiments, the channelization processing may be performed on the second response signal by a digital domain channel, to obtain the digital sampling information corresponding to respective frequency point of the multiple frequency points. At this time, the performing the channelization processing on the second response signal, to obtain the digital sampling information corresponding to respective frequency point of the multiple frequency points includes: acquiring a network model for processing the second response signal; and performing down conversion and filtering processing on the second response signal multiple times by using the network model, to obtain the digital sampling information corresponding to respective frequency point of the multiple frequency points.

Specifically, the network model used for performing channelization processing on the second response signal is pretrained or preconfigured, in order to accurately acquire the digital sampling information corresponding to respective frequency point of the multiple frequency points, after the second response signal is acquired, the network model for processing the second response signal may be acquired, and then down conversion and filtering processing are performed on the second response signal multiple times by using the network model, thereby effectively realizing that the second response signal is processed through by the network model of the digital domain channel, to obtain the digital sampling information corresponding to respective frequency point of the multiple frequency points.

In some other embodiments, in addition to perform channelization processing on the second response signal by using the digital domain channel, an analog domain channel may also be used to perform channelization processing on the second response signal. At this time, the performing channelization processing on the second response signal, to obtain digital sampling information corresponding to respective frequency point of multiple frequency points may include: acquiring an analog circuit for processing the second response signal; processing the second response signal by using a power divider, to obtain multiple child response signals corresponding to the second response signal; and performing down conversion, filtering and analog-to-digital conversion processing on the multiple child response signals respectively by using the analog circuit, to obtain digital sampling information corresponding to respective frequency point of the multiple frequency points.

After the second response signal is acquired, in order to perform channelization processing on the second response signal, the analog circuit for processing the second response signal may be acquired. The analog circuit may be formed by real electronic components, for example, a circuit formed by resistance, inductance, etc., which is used for processing the second response signal. Because the second response signal includes multiple narrowband subcarriers of a preset number, and different narrowband subcarriers correspond to different frequency points. One down conversion operation can only extract the narrowband subcarrier of one frequency point, therefore, in order to accurately acquire the digital sampling information corresponding to respective frequency point of the multiple frequency points, the second response signal is processed by using a power divider, thereby obtaining multiple child response signals corresponding to the second response signal. Specifically, processing the second response signal by using the power divider may include: determining the number of frequency points included in the second response signal; and processing the second response signal by using the power divider, to obtain multiple child response signals, wherein the number of the multiple child response signals is equal to the number of the frequency points.

After the multiple child response signals are acquired, down conversion, filtering and analog-to-digital conversion processing may be respectively performed on the multiple child response signals by using the analog circuit, thereby effectively realizing that the second response signal is processed by the network model of the analog domain channel, to obtain the digital sampling information corresponding to respective frequency point of the multiple frequency points, which not only guarantees the flexibility and reliability of determining the digital sampling information, but also improves the reliability and accuracy of determining the digital sampling information.

Step S503: determining, based on the digital sampling information corresponding to respective frequency point of the multiple frequency points, channel estimation information corresponding to the second response signal.

After the digital sampling information corresponding to respective frequency point of the multiple frequency points is acquired, analytical processing may be performed on the digital sampling information corresponding to respective frequency point of the multiple frequency points, to determine the channel estimation information corresponding to the second response signal. The channel estimation information may include at least one of the following: a start time (corresponding to a start position), frequency offset information, time offset information, etc.

In addition, specific implementations of determining the channel estimation information corresponding to the second response signal are not limited by this embodiment. In some embodiments, the determining, based on the digital sampling information corresponding to respective frequency point of the multiple frequency points, the channel estimation information corresponding to the second response signal may include: acquiring a network model or a preset rule used for performing analytical processing on the digital sampling information, and performing analytical processing on the digital sampling information corresponding to respective frequency point of the multiple frequency points by using the network model or the preset rule, to determine the channel estimation information corresponding to the second response signal.

In some other embodiments, in addition to the implementation of performing the analytical processing on the digital sampling information corresponding to respective frequency point of the multiple frequency points by using the network model or the preset rule, to obtain the channel estimation information, there is also an implementation of determining initial start time and initial frequency offset information firstly, and then determining the channel estimation information by combining the initial start time and the initial frequency offset information. Because the initial start time and the initial frequency offset information are usually obtained directly through a preamble, the determining, based on the digital sampling information corresponding to respective frequency point of the multiple frequency points, the channel estimation information corresponding to the second response signal may include: acquiring preamble information in the digital sampling information corresponding to respective frequency point of the multiple frequency points; determining, based on the preamble information, initial start time and initial frequency offset information which are corresponding to respective frequency point of the multiple frequency points; and determining, based on the initial start time and the initial frequency offset information which are corresponding to respective frequency point of the multiple frequency points, the channel estimation information corresponding to the second response signal.

Specifically, after the digital sampling information corresponding to respective frequency point of the multiple frequency points is acquired, the preamble information in the digital sampling information corresponding to respective frequency point of the multiple frequency points may be determined firstly, and there may be multiple pieces of the preamble information which are corresponding to the multiple frequency points. After the preamble information is acquired, analytical processing may be performed on the preamble information, so that the initial start time and the initial frequency offset information which are corresponding to respective frequency point of the multiple frequency points may be determined. Herein, the initial frequency offset information may be determined by the manner of traversing, that is, after the preamble information corresponding to the multiple frequency points is acquired, a traverse operation may be performed based on the preamble information, so that the initial frequency offset information may be obtained. Then, the channel estimation information corresponding to the second response signal may be determined based on the initial start time and the initial frequency offset information which are corresponding to respective frequency point of the multiple frequency points. In some embodiments, the initial start time and the initial frequency offset information which are corresponding to respective frequency point of the multiple frequency points may be determined as the channel estimation information directly.

It should be noted that the channel estimation information may not only include the initial start time and the initial frequency offset information, but also include initial time offset information. At this time, the determining, based on the digital sampling information corresponding to respective frequency point of the multiple frequency points, the channel estimation information corresponding to the second response signal may include: acquiring preamble information in the digital sampling information corresponding to respective frequency point of the multiple frequency points; determining, based on the preamble information, initial start time, initial frequency offset information and initial time offset information which are corresponding to respective frequency point of the multiple frequency points; and determining, based on the initial start time, the initial frequency offset information and the initial time offset information which are corresponding to respective frequency point of the multiple frequency points, the channel estimation information corresponding to the second response signal.

In terms of the initial start time and the initial frequency offset information, because the initial start time and the initial frequency offset information are obtained by performing simple estimating or rough estimating on the preamble information. At this time, the initial start time and the initial frequency offset information may not be accurate. Therefore, in order to accurately acquire the channel estimation information, a refined estimation operation may be performed based on the initial start time and the initial frequency offset information firstly, to obtain more accurate target start time and target frequency offset information, and then the channel estimation information may be determined based on the target start time and the target frequency offset information. Specifically, the determining, based on the initial start time and the initial frequency offset information which are corresponding to respective frequency point of the multiple frequency points, the channel estimation information corresponding to the second response signal in this embodiment may include: performing processing on the second response signal by using an edge extraction technique and a digital phase locked loop, and in combination with the initial start time and the initial frequency offset information, to obtain target start time and target frequency offset information; and performing non-uniform time sampling and interpolation processing on the target start time and the target frequency offset information, to obtain the channel estimation information corresponding to the second response signal.

However, in terms of the initial frequency offset information in the channel estimation information, because the initial frequency offset information is determined by the manner of traversing, in the process of or after the process of processing the second response signal, when the pre-traversed initial frequency offset information is still preferred frequency offset information, the initial frequency offset information may be determined as target frequency offset information directly. When the pre-traversed initial frequency offset information is not the preferred frequency offset information, a traversing operation should be performed on the frequency offset information anew, to obtain target frequency offset information. At this time, the target frequency offset information is different from the initial frequency offset information.

In addition, in terms of the initial start time, because there may be time offset in the process of performing processing on the second response signal, in order to accurately acquire the target start time, the second response signal may be processed by using an edge extraction technique and a digital phase locked loop. The edge extraction technique is used for identifying the waveform information of data more precisely, and the digital phase locked loop is used for accurately acquiring the start time, time offset information, etc. corresponding to the data signal. In some embodiments, the second response signal may be processed directly by using the edge extraction technique and the digital phase locked loop, so that more accurate start time and time offset information may be obtained.

When the second response signal is processed directly by using the edge extraction technique and the digital phase locked loop, the range of signal processing is larger and the quantity of data processing is larger, so that the efficiency of determining the start time and time offset information is reduced. At this time, in order to further improve the quality and efficiency of determining the start time and time offset information, the second response signal may be processed in combination with the obtained initial start time and initial frequency offset information. Therefore, not only the range of signal processing can be limited and data processing quantity can be reduced, but also relatively accurate time information and time offset information can be obtained. Then, accurate target start time can be obtained through time information and time offset information.

After the target start time and the target frequency offset information are acquired, the target start time and the target frequency offset information correspond to the information of multiple frequency points, and the second response signal corresponds to a complete wideband interval. At this time, in order to accurately acquire the channel estimation information corresponding to the second response signal, non-uniform time sampling and interpolation processing may be performed on the target start time and the target frequency offset information, so that the complete channel estimation information corresponding to the second response signal may be obtained.

In the foregoing implementation steps, the target start time and the target frequency offset information are obtained by performing processing on the second response signal performing processing on the second response signal by using the edge extraction technique and the digital phase locked loop, and in combination with the initial start time and the initial frequency offset information. Then, non-uniform time sampling and interpolation processing are performed on the target start time and the target frequency offset information, to obtain the channel estimation information corresponding to the second response signal, thereby effectively guaranteeing the accuracy and reliability of determining the channel estimation information corresponding to the second response signal, and further improving the level of precision of performing positioning on the radio frequency tag based on the channel estimation information.

In addition, before the channelization processing is performed on the second response signal, that is, before the channel estimation information corresponding to the second response signal is determined, in order to acquire more accurate channel estimation information, the method in this embodiment may also include: determining the number of antennas used for transmitting the second response signal; and in the case of transmitting the second response signal based on antennas of the number of antennas, performing processing on the second response signal by using an adaptive beamforming technology, to obtain a more accurate second response signal.

Step S504: determining, based on the channel estimation information and the area information, the positioning information of the radio frequency tag.

After the channel estimation information and the area information are acquired, the positioning information of the radio frequency tag may be determined in a space area limited by the area information based on the channel estimation information, thereby effectively realizing the operation of positioning the radio frequency tag based on the second response signal. A specific implementation of determining the positioning information of the radio frequency tag is not limited by this embodiment. In some embodiments, a network model used for analyzing and processing the channel estimation information and the area information is pretrained, and then the network model is used to process the channel estimation information and the area information, to determine the positioning information of the radio frequency tag.

In some other embodiments, the determining, based on the channel estimation information and the area information, the positioning information of the radio frequency tag may include: determining, based on the channel estimation information, phase information corresponding to respective frequency point of the multiple frequency points; and determining, based on the phase information corresponding to respective frequency point of the multiple frequency points and the area information, the positioning information of the radio frequency tag.

Specifically, because the channel estimation information may include start time, frequency offset information, time offset information, etc., and the foregoing start time, frequency offset information and time offset information are related to phase information, after the channel estimation information is acquired, the start time, frequency offset information and time offset information included in the channel estimation information may be determined. Then, analytical processing is performed on the start time, the frequency offset information and the time offset information, so that the phase information corresponding to respective frequency point of the multiple frequency points may be determined. After the phase information corresponding to respective frequency point of the multiple frequency points is acquired, because the phase information corresponding to radio frequency tags in different areas are different, analytical processing may be performed on the phase information corresponding to respective frequency point of the multiple frequency points and the area information, so that the positioning information of the radio frequency tag may be determined.

In this embodiment, by acquiring the area information corresponding to the radio frequency tag, and performing the channelization processing on the second response signal, the digital sampling information corresponding to respective frequency point of the multiple frequency points is obtained. Then, the channel estimation information corresponding to the second response signal is determined based on the digital sampling information corresponding to respective frequency point of the multiple frequency points, and the positioning information of the radio frequency tag is determined based on the channel estimation information and the area information, so that the accuracy and reliability of determining the positioning information corresponding to the radio frequency tag may be effectively guaranteed, and then it is conducive to improve the quality and efficiency of performing communication connection to the radio frequency tag based on the positioning information.

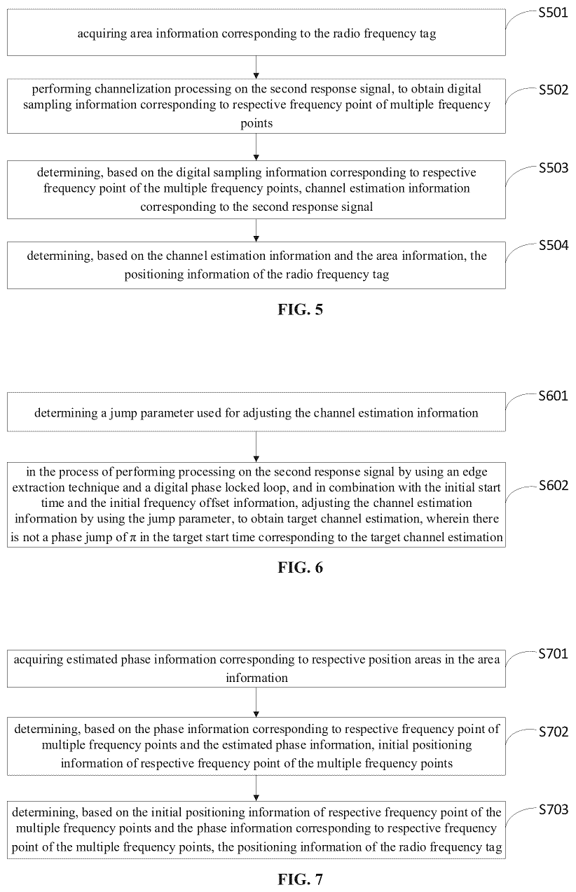

FIG. 6 is a schematic flow chart of another radio frequency communication method provided by an embodiment of the present application. On the basis of the foregoing embodiments, with reference to FIG. 6, after determining the initial start time and the initial frequency offset information which are corresponding to respective frequency point of multiple frequency points, the method in this embodiment may further include:
Step S601: determining a jump parameter used for adjusting the channel estimation information.

Herein, in terms of the target start time corresponding to the channel estimation information, in the process of performing processing on the second response signal, there may be a phase jump of π in the target start time. The situation of the foregoing phase jump of π will directly affect the deviation of performing positioning on the radio frequency tag. Therefore, in order to eliminate the situation where there is a phase jump of π in the target start time, a jump parameter used for adjusting the channel estimation information may be determined firstly, and the jump parameter may be a preconfigured parameter used for performing a traversing operation on time information. In some embodiments, the jump parameter may include at least one of the following: a parameter corresponding to the −π phase, a parameter corresponding to the 0 phase, and a parameter corresponding to the π phase.

In addition, specific implementations of determining the jump parameter used for adjusting the channel estimation information are not limited by this embodiment. In some embodiments, the jump parameter is a preconfigured parameter stored in a preset area or a preset device. At this time, the jump parameter used for adjusting the channel estimation information may be acquired by accessing the preset area or the preset device. In some other embodiments, the jump parameter may be generated by a user's parameter configuration operation. At this time, the determining the jump parameter used for adjusting the channel estimation information may include: acquiring a display interface used for editing or configuring a jump parameter, acquiring a parameter configuration operation which is input by a user in the display interface, and determining, based on the parameter configuration operation, the jump parameter used for adjusting the channel estimation information.

Step S602: in the process of performing processing on the second response signal by using an edge extraction technique and a digital phase locked loop, and in combination with the initial start time and the initial frequency offset information, adjusting the channel estimation information by using the jump parameter, to obtain target channel estimation, wherein there is not a phase jump of π in the target start time corresponding to the target channel estimation.

Specifically, because the initial start time in the channel estimation information is determined by the manner of traversing, after the jump parameter is acquired, the time information in the channel estimation information may be traversed again based on the jump parameter. If the start time after the traversal is same as the initial start time obtained by the history traversal, it means that there is not a phase jump of π in the time information obtained at this time, and then there is no need to adjust the initial start time. If the start time after the traversal is different from the initial start time obtained by the history traversal, it means that there is a phase jump of π in the time information obtained at this time, and it is necessary to update the start time obtained by the history traversal, so that the target channel estimation may be obtained by the updated start time. At this time, there is not the phase jump of π in the target start time determined by the target channel estimation, which may further guarantee the accuracy and reliability of performing positioning on the radio frequency tag based on the target channel estimation information.

FIG. 7 is a schematic flow chart of determining, based on phase information corresponding to respective frequency point of the multiple frequency points and area information, positioning information of a radio frequency tag provided by an embodiment of the present application. On the basis of the foregoing embodiments, with reference to FIG. 7, specific implementations of determining the positioning information of the radio frequency tag are not limited by this embodiment. In some embodiments, a pretrained network model may be used to perform analytical processing on the phase information corresponding to respective frequency point of the multiple frequency points and the area information, so that the positioning information of the radio frequency tag is determined directly. In some other embodiments, the determining, based on the phase information corresponding to respective frequency point of the multiple frequency points and the area information, the positioning information of the radio frequency tag may include:
Step S701: acquiring estimated phase information corresponding to respective position areas in the area information.

In terms of the area information, the area information is usually formed by multiple position areas or grid areas. At this time, in order to accurately identify the positioning information of the radio frequency tag, in terms of all position areas included in the area information, each position area corresponds to standard estimated phase information. It should be understood that different position areas usually correspond to different estimated phase information. The foregoing estimated phase information is used as reference information for determining the positioning information of the radio frequency tag.

Specifically, specific implementations of acquiring estimated phase information are not limited by this embodiment. In some embodiments, the estimated phase information may be collected through prior experiments, the mapping relation between the collected estimated phase information and the position area may be stored in a preset area or a preset device, and the estimated phase information corresponding to each position area may be acquired by accessing the preset area or the preset device. In some other embodiments, the estimated phase information may be configured based on prior empirical values. At this time, the acquiring the estimated phase information corresponding to each position area in the area information may include: acquiring an interactive interface used for configuring the estimated phase information, determining an execution operation which is input by a user in the interactive interface, and acquiring the estimated phase information corresponding to each position area based on the execution operation, thereby effectively guaranteeing the stability and reliability of acquiring the estimated phase information corresponding to each position area.

Step S702: determining, based on the phase information corresponding to respective frequency point of the multiple frequency points and the estimated phase information, initial positioning information of respective frequency point of the multiple frequency points.

Because each position area in the area information corresponds to its own estimated phase information, and the estimated phase information corresponding to different position areas are different, after the phase information corresponding to each frequency point and the estimated phase information are acquired, analytical processing may be performed on the phase information corresponding to each frequency point and the estimated phase information, to determine initial positioning information of each frequency point. In some embodiments, a network model used for performing analytical processing on the phase information corresponding to each frequency point and the estimated phase information is preconfigured, after the phase information corresponding to each frequency point and the estimated phase information are acquired, the phase information corresponding to each frequency point and the estimated phase information may be input to the network model, so that the initial positioning information of each frequency point output by the network model may be obtained.

In some other embodiments, the determining, based on the phase information corresponding to each frequency point and the estimated phase information, the initial positioning information of each frequency point may include: acquiring a similarity between the phase information corresponding to each frequency point and the estimated phase information corresponding to each position area; and determining, based on the similarity, the initial positioning information of each frequency point.

Specifically, after the phase information corresponding to each frequency point and the estimated phase information corresponding to each position area are acquired, the similarity between the phase information corresponding to each frequency point and the estimated phase information corresponding to each position area may be acquired. The similarity may be determined by the following manner, such as Euclidean distance, standardized Euclidean distance, Manhattan distance, Hamming distance, Chebyshev distance, Mahalanobis distance, Lance and Williams distance, Minkowski distance, Edit distance, cosine similarity, Jaccard similarity, Dice coefficient, etc.

It is noted that because the number of frequency points corresponding to the phase information is multiple and the number of position areas corresponding to the estimated phase information is multiple, the number of obtained similarities is multiple. After the foregoing multiple similarities are acquired, processing may be performed on all similarities, to determine the initial positioning information of each frequency point. In some embodiments, the determining, based on the similarity, the initial positioning information of each frequency point may include: determining a maximum similarity in all similarities, and determining, in all position areas, a target position area corresponding to the maximum similarity. At this time, the number of the target position area may be one or multiple, and then the positioning information corresponding to the target position area is determined as the initial positioning information of the radio frequency tag.

In some other embodiments, the determining, based on the similarity, the initial positioning information of each frequency point may include: determining, in all the similarities, all similarities which are greater than a preset threshold, wherein the preset threshold may be 85%, 90% or 95%, etc. Then, a target position area corresponding to each of the foregoing all similarities are determined in all the position areas. At this time, the number of the target position area may be one or multiple. Then, the position information corresponding to the target position area is determined as the initial positioning information of the radio frequency tag, so that the flexibility and reliability of determining the initial positioning information is effectively guaranteed.

Step S703: determining, based on the initial positioning information corresponding to all frequency points and the phase information corresponding to all frequency points, the positioning information of the radio frequency tag.

Because all frequency points are obtained by transmitting radio frequency signals to one radio frequency tag, theoretically, the initial positioning information obtained by sampling information of all frequency points are the same. However, there are usually some disturbances or errors in the process of signal processing or signal transmitting, and it is likely that the initial positioning information of all frequency points may be different. Therefore, in order to determine the positioning information of the radio frequency tag more accurately, after the initial positioning information of all frequency points are acquired, joint analytical processing may be performed on the initial positioning information of all frequency points and the phase information corresponding to all frequency points, to accurately determine the positioning information of the radio frequency tag. In some embodiments, a network model used for performing analytical processing on the initial positioning information corresponding to all frequency points and the phase information corresponding to all frequency points is preconfigured, after the initial positioning information corresponding to all frequency points and the phase information corresponding to all frequency points are acquired, the initial positioning information corresponding to all frequency points and the phase information corresponding to all frequency points may be input to the network model, so that the unique positioning information of the radio frequency tag, which is output by the network model, may be obtained.

In some other embodiments, the determining, based on the initial positioning information corresponding to all frequency points and the phase information corresponding to all frequency points, the positioning information of the radio frequency tag may include: determining, based on the initial positioning information corresponding to all frequency points and the phase information corresponding to all frequency points, probability information that the radio frequency tag is located in each position area; determining, based on the probability information, a target position area corresponding to the maximum probability; and determining, based on the target position area, the positioning information of the radio frequency tag.

Specifically, after the initial positioning information corresponding to all frequency points and the phase information corresponding to all frequency points are acquired, analytical processing may be performed on the initial positioning information corresponding to all frequency points and the phase information corresponding to all frequency points, to determine the probability information that the radio frequency tag is located in each area. Because the foregoing initial positioning information corresponding to all frequency points are used for determining the positioning information of one radio frequency tag, in order to accurately acquire the positioning information of the radio frequency tag, a joint processing operation may be performed on the initial positioning information corresponding to all frequency points, so that probability information that the radio frequency tag is located in each position area may be obtained.

After the probability information that the radio frequency tag is located in each position area is acquired, a maximum probability may be determined in all probability information, and then a target position area corresponding to the maximum probability is determined. Because the probability that the target position area is the positioning information of the radio frequency tag is maximum, the positioning information of the radio frequency tag may be directly determined based on the target position area. In some embodiments, the target position area may be directly determined as the positioning information of the radio frequency tag, or, a center point of the target position area may be acquired, and then the center point is determined as the positioning information of the radio frequency tag.

In this embodiment, the estimated phase information corresponding to each position area in the area information is acquired, then the initial positioning information of each frequency point is determined based on the phase information corresponding to each frequency point and the estimated phase information, and the positioning information of the radio frequency tag is determined based on the initial positioning information corresponding to all frequency points and the phase information corresponding to all frequency points, thereby effectively realizing that the positioning information of the radio frequency tag is accurately acquired, which is conducive to improve the stability and reliability of performing communication connection to the radio frequency tag, and further guarantees the practicality of this method.

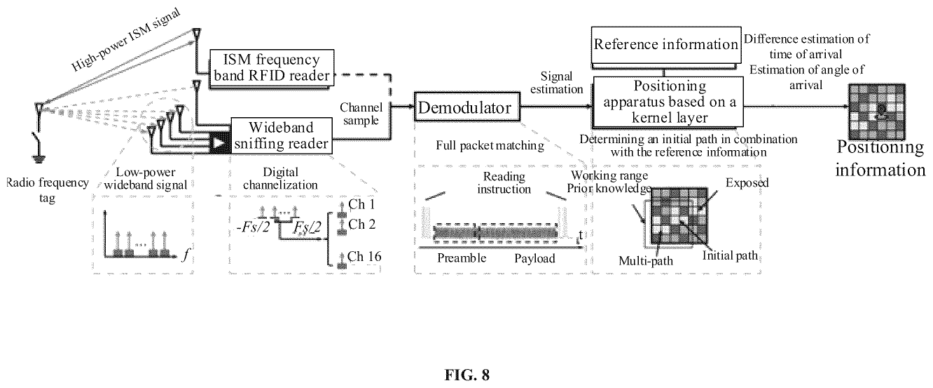

In a specific application, as an example, an ISM frequency band RFID reader is taken as a first signal reader, and a wideband sniffing reader is taken as a second signal reader. This application embodiment provides a practical and accurate positioning method for a radio frequency tag based on a wideband sniffing system architecture. The positioning method may be realized by a wideband sniffing system architecture in which the communication and positioning are separated. With reference to FIG. 8, the wideband sniffing system may include: a signal reader (including: an ISM frequency band RFID reader and a wideband sniffing reader), a demodulator communicated with the signal reader, and a positioning apparatus based on a kernel layer, and the positioning apparatus is communicated with the demodulator. Specifically, the positioning method for the radio frequency tag realized based on the wideband sniffing system may include the following steps:

Step 1: when there is a radio frequency tag in a preset area, the ISM frequency band RFID reader may transmit a high-power ISM signal to the radio frequency tag, and the wideband sniffing reader may transmit a low-power wideband signal to the radio frequency tag.

The wideband sniffing system (hereinafter simply referred to as the system) provided by this application embodiment may realize an operation of separating communication and positioning for the radio frequency tag. At this time, the readers in the system may be divided into the ISM frequency band RFID reader and the wideband sniffing reader. The foregoing ISM frequency band RFID reader is a conventional RFID reader, which is applied to GEN II (i.e., the network foundation consisting of the wireless radio frequency identification (RFID) technology, the Internet and the electronic product code (EPC)) protocol, and may complete scanning, reading and conflicting processing on a RFID tag, to ensure that a large number of radio frequency tags in a preset working space may communicate with a reader serially and orderly.

In addition, the wideband sniffing reader may realize reading and channel estimation on a wider frequency band, thereby providing information for the positioning of the radio frequency tag. Specifically, the low-power wideband signal transmitted by the wideband sniffing reader may adopt a multi-sine carrier signal, for example, it may be 16 sine carrier signals. As shown in FIG. 8, the wideband sniffing reader may include a transmitter and multiple receivers. At the transmitter, multiple narrowband subcarriers of different frequencies may be generated, and the multiple narrowband subcarriers of different frequencies are integrated and then transmitted. At the receiver, multiple discrete narrowband subcarriers may be used to sample wideband information, so that the channel estimation over the entire wideband may be fitted. Narrowband subcarriers may obtain more accurate single frequency channel estimation, which is conducive to improve the accuracy and work distance of the channel estimation. At the same time, because the wideband signal is transmitted once after integration, in terms of a single radio frequency tag, only a single collection is required to obtain all wideband information for positioning, which is conducive to improve processing ability and delay appearance of the system. It is noted that the low-power wideband signal transmitted by the wideband sniffing reader may not be a multi-sine carrier signal, but may use another form of carrier such as OFDM, etc. It is noted that, in terms of the wideband sniffing reader and the ISM frequency band RFID reader of the system, there may be various duplex designs in which there are separated transceiving and integrated transceiving.

In this embodiment, the high-power ISM signal is used for transmitting, and the low-power wideband signal is used for positioning, which effectively realizes an efficient and legal RFID wideband positioning operation, can satisfy relevant regulations of the radio regulatory committee, will not be impossible to be achieved due to the limited spectrum resources for UHF frequency band RFID communication, and satisfies the strict requirements of spurious transmit power.

Step 2: the radio frequency tag reflects the high-power ISM signal, so that the ISM frequency band RFID reader receives a first reflection signal. Similarity, the radio frequency tag reflects the low-power wideband signal, so that the wideband sniffing reader receives a second reflection signal.

In the process of a conventional ISM frequency band RFID reader communicating with a RFID radio frequency tag by a high-power ISM signal, a chip in the radio frequency tag may change its own reflection coefficient, so that the received high-power ISM signal may be reflected and the first response signal may be generated.

In terms of the wideband sniffing reader, when the wideband sniffing reader transmits a wideband carrier signal (i.e., a low-power wideband signal), due to the limitation of the spurious transmit power, the low-power wideband signal is not enough to activate the radio frequency tag, thus the communication with the radio frequency tag also cannot be completed. In a specific implementation, although the low-power wideband signal transmitted by the wideband sniffing reader cannot activate the radio frequency tag, it may also be reflected by the radio frequency tag, and it is also affected by the change of the reflection coefficient of the radio frequency tag, so that the second reflection signal corresponding to the low-power wideband signal may be generated. Then the channel estimation may be performed over the wideband based on the second reflection signal, to perform a positioning operation on the radio frequency tag.

Step 3: after the wideband sniffing reader acquires the second reflection signal, channelization processing may be performed on the second reflection signal, to obtain digital sampling information of multiple frequency points corresponding to the second reflection signal.

In terms of the received second reflection signal, the wideband sniffing reader may support two different channelization modes, which are digital domain channelization and analog domain channelization respectively. When the digital domain channelization is selected, the wideband sniffing reader performs a wideband sampling operation with high number of bits (referring to the number of bits being larger, for example, the number of bits is greater than 16). In a case where channelization processing is performed on the second reflection signal by using the digital domain channelization, independent down conversion processing and filtering processing may be included, and digital sampling on multiple frequency points (i.e., multiple channels) may be obtained after the channelization processing. The advantage of performing the channelization processing on the second response signal by the digital domain channelization is that the number of radio frequency links is reduced, and it facilitates the processing of channels of any scale. At the same time, for the same antenna, more accurate time synchronization may be realized between different channels.

When the analog domain channelization is selected, the wideband sniffing reader may perform signal processing on the second response signal by a power divider, to obtain multiple sub-reflection signals. Then, an analog domain channelization processing operation is performed, which specifically includes: performing down conversion processing and filtering processing on the analog domain, and then performing sampling by an analog-to-digital converter, to obtain digital sampling on multiple frequency points. The advantage of performing the channelization processing on the second reflection signal by the analog domain channelization is that it does not require a high sampling frequency and a high sampling bit number for analog-to-digital/digital-to-analog conversion, hardware requirements are low, and switching may be performed quickly between different frequency bands. It may be understood that those skilled in the art may select different modes according to actual requirements, to perform the channelization processing operation on the second reflection signal.

In the process of actual processing, the digital domain channelization mode requires a higher dynamic range. However, a multi-sine subcarrier has a narrow bandwidth on the frequency domain, which may effectively reduce the effect caused by received thermal noise and other ground noises on the spectrum. In addition, the multi-sine subcarrier also provides gains to eliminate the self-interference during full-duplex, thus the second reflection signal transmitted by the wideband sniffing reader is preferably a multi-sine subcarrier signal. In addition, because the radio frequency tag may perform double-sideband modulation in the process of reflecting the carrier of the reader, the main carrier component of the self-interference may be filtered out by identifying a double-sideband modulation signal for a single tone.

In addition, when the wideband sniffing reader transmits the second radio frequency signal is transmitted to the radio frequency tag, and receives the second reflection signal corresponding to the second radio frequency signal, because the power limits of a high-power ISM signal and a low-power wideband signal are different, and the transmission power difference is large, after the low-power wideband signal is received, the high-power component of the ISM frequency band may be filtered out firstly by a band-stop filter. In addition, the radio frequency tag and antenna, which are used for positioning, should be suitable for transmitting and receiving the low-power wideband signal, and have a better frequency response on the UHF frequency band. The wideband sniffing system architecture is designed with a corresponding radio frequency circuit, antenna, and radio frequency tag. It should be noted that this technical solution may be used in both the RFID of non-UHF frequency band and other backscatter techniques.

Step 4: processing is performed on the digital sampling information of multiple frequency points by using a demodulator, to obtain channel estimation information.

After the digital sampling information of multiple frequency points are received, the wideband sniffing reader and the ISM frequency band reader may transmit data to the demodulator synchronously. At this time, the demodulator may not only acquire the digital sampling information transmitted by the wideband sniffing reader, but also acquire data information transmitted by the ISM frequency band reader. The data information may include identification information (EPCID) of the radio frequency tag, time information, auxiliary demodulation information such as frequency offset information or time offset information, etc. Then, the demodulator may process, by combining the data information transmitted by the ISM frequency band reader, the digital sampling information transmitted by the wideband sniffing reader, which may improve the quality and efficiency of acquiring the channel estimation information.

In some other embodiments, the wideband sniffing reader may transmit the obtained digital sampling information of multiple frequency points to the demodulator, and the demodulator may perform an independent demodulation operation on the digital sampling information transmitted by the wideband sniffing reader. At this time, the demodulator does not acquire the data information transmitted by the ISM frequency band reader. Because both the activation for the radio frequency tag and conflict detection for the radio frequency tag are completed by the ISM frequency band RFID reader, the wideband sniffing reader is only responsible for sniffing a channel for a RFID tag over a wider frequency band, so the separation of communication and positioning for the radio frequency tag is effectively realized.

In addition, an adjusting algorithm used for processing the digital sampling information of multiple frequency points is preconfigured in the demodulator, and the adjusting algorithm may efficiently process digital sampling information with a lower power and a low signal-to-noise ratio. Specifically, the adjusting algorithm used for processing the digital sampling information of multiple frequency points may include: optimization strategies, such as full packet matching, phase locked loop tracking offset correction, phase jump of π elimination, etc. The full packet matching and the phase locked loop tracking included in the foregoing demodulation process are not necessary, and those skilled in the art may make a selection according to the actual requirements for the signal-to-noise ratio.

The full packet matching strategy refers to that the digital sampling information of multiple frequency points may be transmitted by using an entire RFID packet, and then a demodulator may perform channel estimation on the entire RFID packet. Compared with performing demodulation and channel estimation by only using a preamble, performing channel estimation by using the entire RFID packet may extend a signal length, and coherent integration in the time domain may further increase the signal-to-noise ratio.

After the second reflection signal is acquired, because the second reflection signal usually includes some noise information or clutter information in the process of transmitting the second reflection signal, in order to accurately perform a positioning operation based on the second reflection signal, the number of antennas used for transmitting the second reflection signal may be determined firstly. When the second reflection signal is transmitted based on the antennas of the number of antennas, adaptive beamforming technique is used to process the second response signal. By performing combining and cancelling interference on multiple channels, coherent noise is suppressed and the signal-to-noise ratio is further improved, so that a more precise second reflection signal may be obtained.

Specifically, in terms of the second reflection signal, because the second reflection signal is a mixed signal including multiple narrowband subcarriers, the demodulator may demodulate the preamble of the mixed signal including the subcarriers after the demodulator acquires the second reflection signal. The demodulation process may include traversing the signal start position (or referred to as the signal start time) and the frequency offset information, perform accelerate computation by using the fast Fourier transform (FFT) algorithm, so that the initial start time and the initial frequency offset information which are corresponding to respective frequency point of multiple frequency points may be obtained. The foregoing initial start time and the initial frequency offset information may be used as determined preliminary template parameters.

After the roughly estimated preliminary template parameters are acquired, the demodulator may perform a refined estimation operation on the start position and frequency offset information. Specifically, the carrier component of the second reflection signal may be further purified by using the edge extraction technique and the digital phase locked loop, and in combination with the preliminary template parameters, to obtain the target start position and target frequency offset information. That is, the finely estimated template parameter results are obtained. Then, non-uniform time sampling and interpolation processing may be performed on the finely estimated template parameter results, so that the channel estimation information corresponding to the second reflection signal is obtained, that is, the operation of restoring the carrier signal is accurately realized.

In addition, in the process of acquiring the initial start time and the initial frequency offset information, the system may usually adopt an M4 modulation mode to perform an adjustment operation on a signal. In this way, although there is π phase difference in the estimation of the initial start time, the information in the packet may stilled be correctly demodulated. This is good for obtaining correct demodulation results, but will cause half-period ambiguity (i.e., jump of π) in the channel estimation. However, in a case where the demodulator obtains a target channel estimation based on the digital phase locked loop technology and Viterbi soft demodulation, the jump parameter used for adjusting the channel estimation information may be used to adjust the channel estimation information, so that the target channel estimation may be obtained. There is not a phase jump of π in the target start time corresponding to the target channel estimation. This may increase the unambiguous range of positioning and distance resolution by two times. The high coupling of the entire demodulation process is larger, which is conducive to improve the signal-to-noise ratio and channel estimation accuracy of the system. It should be noted that there are multiple encoding modes for a demodulation algorithm, for example, M8, Manchester code, and Bi-phase space code all are applied. In the process of eliminating the jump of π, a soft demodulator may use a non-Viterbi demodulation algorithm.

Step 5: the positioning information of the radio frequency tag is determined based on the channel estimation information.

In terms of the system, the radio frequency signal used by the system is usually a UHF RFID signal. Because the positioning for UHF RFID is near field positioning, its working wavelength is often around 30 cm. In the process of positioning, multiple antennas are usually used to construct an antenna array for the requirements of angle measurement. The aperture of the array is generally one meter to two meters, while the communication/positioning distance of RFID is usually around ten meters, or more than ten meters. Because the communication distance cannot satisfy the requirements of being much larger than the antenna aperture, it cannot be assumed that the signal is incident as a plane wave, but a spherical wave model should be used. Based on the foregoing statements, in this embodiment, determining the positioning information of the radio frequency tag based on the channel estimation information may be realized by a near field positioning framework based on a “kernel-layer” structure. The foregoing near field positioning framework based on the “kernel-layer” structure is an algorithm framework for near field positioning, which does not perform “angle-distance” division on the information, but directly traverses the potential working area, and the process of traversal mixes angle and distance estimation.

The near field positioning framework based on the “kernel-layer” structure may include a “kernel function” and a “layer function”. The kernel function reflects the confidence level for the information of a single channel, and the layer function is used for reflecting a gain in the joint process of the information of multiple channels. In the process of the near field positioning framework based on the “kernel-layer” structure traversing the channel estimation information, “distance-angle” estimation may be performed firstly by using the channel estimation information of a single channel, and the estimation algorithm is called as “kernel function”; then, the information of multiple channels is integrated for further judgement, and the estimation algorithm is called as “layer function”. The separation of the kernel function and the layer function is conducive to optimize the positioning algorithm by combining physical process of communication and the prior knowledge of the scene. In the process of actual deployment, the forms of the kernel function and the layer function may be adjusted for different scenes and requirements. For example, kernel functions based on forms such as tangent, sine, step function, etc. are used; and layer functions based on time domain filtering and an angle domain spectrum estimation algorithm are used, to realize accurate positioning effects.

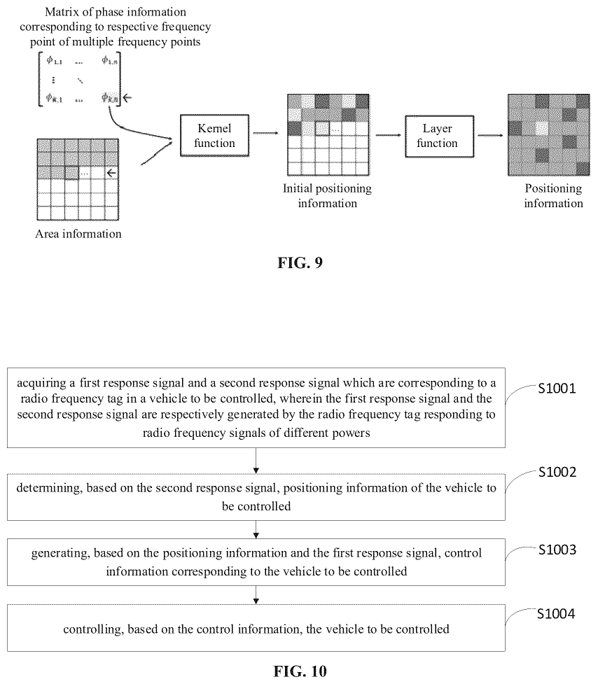

Specifically, referring to FIG. 9, after the channel estimation information of each frequency point or each channel is acquired, phase information θ(g_{(i,j)}, Aₖ, fₗ) may be separated out based on the channel estimation information of each channel, wherein g_{(i,j)} is a grid point traversed in a two-dimensional space, Aₖ is the k-th antenna, and fₗ is the l-th frequency point. Because the phase information contains the distance information of the signal propagation of a specific RFID tag during the communication, the specific formulation is:

$$θ ( {g}_{( i , j )} , {A}_{k} , {f}_{l} ) = \frac{2 π {f}_{l}}{c} \times ( {d}_{T x - T a g} + {d}_{T a g - R x} ) ( mod 2 π ) ,$$

and d_{Tx-Tag} in the foregoing formulation is the distance from the transmitter of an antenna to a radio frequency tag, and d_{Tag-Rx} is the distance from the radio frequency tag to the receiver of the antenna. It can be seen from the above that the phase information is related to both the distance (Tx-Tag) from the transmitter of the antenna to the radio frequency tag, and the distance (Tag-Rx) from the radio frequency tag to the receiver of the antenna.

Therefore, after the phase information corresponding to each channel estimation information is acquired, the kernel function may be used to perform analytical processing on the phase information and the area information which are corresponding to each channel estimation information, to determine the initial positioning information corresponding to the radio frequency tag. Specifically, the initial positioning information may be obtained by processing a template signal corresponding to each position area in the area information. At this time, after the phase information corresponding to each channel estimation is received, the phased information may be compared with the template signal. The manner of comparing may be hᵢ=Σₜr(t)I*(t), wherein I(t) is the template signal, r(t) is the received phased information corresponding to the signal of each channel estimation, and hᵢ is the similarity between the phase information and the template signal. In terms of the template signal, in the case of low load, the identification of the radio frequency tag may be provided by the information exchange of the ISM frequency band reader, to generate the template signal. Or, the template signal may be a preconfigured or prestored reference phase signal. After the similarity information is acquired, the initial positioning information may be determined based on the similarity information. Generally, at least one position area corresponding to a higher similarity or the maximum similarity may be determined as the initial positioning information.

After the initial positioning information is acquired, the initial positioning information may be processed by using the layer function and combining the phase information corresponding to all channel estimation information, so that the target positioning information corresponding to the radio frequency tag may be obtained. In a specific implementation, an exponential function may be used as the kernel function and an accumulation function may be used as the layer function, and an approximate inverse fast Fourier transform (IFFT) processing may be realized, so that the joint estimation of time difference of arrival (DTOA) and angle of arrival (AOA) is completed, and the precise positioning information of the radio frequency tag is obtained. Channel estimation may be performed on a single channel firstly, and then a joint processing operation may be performed on multiple pieces of channel information, to accurately determine the positioning information of the radio frequency tag. Herein, the algorithm formula of the near field positioning framework based on the “kernel-layer” structure is: P(g_{(i,j)})=|Σₗ₌₁^{L}Σₖ₌₁^{K}e^{-j(ϕ}^{_{k,l}}^{)-θ(g}^{_{i,j}}^{,k,l)}|, wherein P(g_{(i,j)}) is the information of the probability that the radio frequency tag is located at each grid point traversed in a two-dimensional space, θ(g_{i,j}, k, l) is the phase information obtained by performing an separation operation on the channel estimation information of each channel, and j(ϕ_{k,l}) is the initial positioning information which is estimated in advance.

Compared to related technologies, in the technical solution provided by this application embodiment, it does not need to cooperate with any mechanical motion unit. Only a pre-calibration needs to be done before leaving the factory, and the collection of all wideband information may be completed in one time, which greatly reduces the time delay of positioning. In addition, the gain in distance resolution brough by the wide frequency band may help to distinguish multipath, which effectively improves the reliability of positioning when compared to the RFID position techniques based on frequency hopping, OFDM, FMCW, etc. In addition, the wideband sniffing based on a multi-sine subcarrier may complete the information collection process by using an extremely low transmit power, and guarantee real time processing. For the channel information on each subcarrier, the self-interference elimination may be efficiently completed due to the coherent property of a sine carrier and double-sideband modulation of RFID, thereby improving the accuracy of channel estimation data and improving the positioning precision.

Specifically, this application embodiment may achieve the following technical effects:
(1) The ISM frequency band used by commercial RFID is utilized to communicate and the channel information of a lower power wideband signal is utilized to position. Moreover, the RFID reader uses the design in which transmitting and receiving are separated, and wide band and narrow band are separated. Specifically, the ISM frequency band signal and the wideband activation signal are transmitted by different antennas, and the special made antenna array is used to receive the wideband signal. At the wideband end, multiple sine subcarriers are transmitted in one time, so that the accurate channel estimation information may be obtained in a single communication process. In addition, although the transmit power of the wideband signal is far less than the power for the ISM frequency band, the working distance and the reading rate which are close to the ISM frequency band may be realized. In addition, the distance resolution of the system has a great gain when compared to the tradition RFID positioning system, which may effectively improve multipath resolution and removing capability, so that the positioning precision and the reliability of positioning are improved.
(2) The system performs a targeted optimization on the low power and multi-channel wideband sampling in the process of digital demodulation and the radio frequency circuit. Specifically, multiple optimization strategies including adaptive beamforming, phase locked loop matching, soft demodulation traversal, etc. are adopted, which realizes a demodulation algorithm with high signal-to-noise ratio, and may perform transceiving, processing, and demodulation on the multi-frequency point, multi-antenna and multi-channel information in real time, and output the accurate channel estimation result without jump of π in real time. In addition, the time of information collecting and calculating required by the system for positioning a single tag is less than tag communication time. Therefore, channel estimation and positioning result update may be performed in real time, which is of great significance for the multi-label and high dynamic scenario.
(3) Based on the property of near field positioning, the system performs hierarchical processing on the multi-channel information. Specifically, for the multi-channel information provided by the wideband signal and the antenna array, the kernel function uses single channel information to perform position estimation, and the layer function integrates multiple kernel functions to perform position estimation, and a high precision positioning result is obtained by layer functions such as noise removal, multipath removal, etc. This framework may be convenient to perform targeted optimization on the main problems faced by the RFID positioning in different scenarios, thereby achieving customized, high reliable, and high-precision RFID positioning information.

FIG. 10 is a schematic flow chart of a vehicle control method provided by an embodiment of the present application. Referring to FIG. 10, this embodiment provides a vehicle control method, and the execution body of this method may be a vehicle control apparatus. It may be understood that the vehicle control apparatus may be implemented in software, or a combination of software and hardware. In a specific implementation, the vehicle control apparatus may be deployed in a 4G network, a 5G network, a 6G network, a private network, or a public network, to realize a control operation on a vehicle. Specifically, the vehicle control method may include:
Step S1001: acquiring a first response signal and a second response signal, which are corresponding to a radio frequency tag in a vehicle to be controlled, wherein the first response signal and the second response signal are respectively generated by the radio frequency tag responding to radio frequency signals of different powers.
Step S1002: determining, based on the second response signal, positioning information of the vehicle to be controlled.
Step S1003: generating, based on the positioning information and the first response signal, control information corresponding to the vehicle to be controlled.
Step S1004: controlling, based on the control information, the vehicle to be controlled.

Specifically, during the driving process of the vehicle to be controlled (a driverless vehicle or a manually driven vehicle) moves, in order to realize the accurate and effective control on the vehicle to be controlled, the first response signal and the second response signal which are corresponding to the radio frequency tag in the vehicle to be controlled may be acquired. The first response signal is used for determining running status data, vehicle identification and an IP address of the vehicle. The second response signal is used for determining positioning information of the vehicle, that is, it is used for determining the specific positioning information of the vehicle to be controlled in a preset area (for example, a parking lot, a dispatching area where the dispatching vehicle is located, etc.), to accurately control the vehicle to be controlled based on the specific positioning information.

In some embodiments, in order to improve the stability and reliability of controlling the vehicle, sensors may be set on the vehicle to be controlled, and the running status data corresponding to the vehicle to be controlled may be quickly acquired by the sensors. The running status data corresponding to the vehicle to be controlled may include at least one of the following: a current speed of the vehicle, a driving direction of the vehicle, and environmental information. Herein, the environmental information includes the locations of surrounding objects, the speed of a vehicle in front of the vehicle, a road speed limit of the road where the vehicle is located. In some embodiments, the sensors may include an image acquisition sensor, a radar sensor, and a global positioning system (GPS). Specifically, the running status data corresponding to the vehicle to be controlled is determined by the image acquisition sensor, the radar sensor and the GPS.

After the second response signal is acquired, positioning information of the vehicle to be controlled in a preset area may be determined based on the second response signal, which may realize that the positioning information of the vehicle to be controlled in the preset area can still be accurately determined without a network. Then, control information may be generated based on the first response signal and the positioning information, and the control information may be used for assisting the vehicle to be controlled to park in the preset area, or may be used for assisting the vehicle to be controlled to pass through the preset area, etc. Then, the vehicle to be controlled may be controlled based on the control information, to further improve the practicality of this method.

It should be noted that in terms of the vehicle control apparatus, the vehicle control apparatus may be set on a vehicle, or the vehicle control apparatus may be set independently from the vehicle. At this time, the vehicle control apparatus may perform a communication connection with the CPU of the vehicle.

In addition, in terms of the vehicle control apparatus, the vehicle control apparatus may be adjusted according to different vehicles, that is, according to different types of vehicles, algorithm modules included in the vehicle control apparatus may also be different. At this time, the vehicle control apparatus may not only realize the control operation for automatic driving of the vehicle, but also realize other operations. For example, different vehicle control apparatuses may be involved for logistics vehicles, public service vehicles, medical service vehicles and terminal service vehicles. The algorithm modules included in the vehicle control apparatuses are illustrated below with examples for these four types of autonomous vehicles:

Herein, the logistics vehicles refer to vehicles used in logistics scenarios. For example, they may be logistics vehicles with an automatic sorting function, logistics vehicles with refrigeration and heat preservation functions, and logistics vehicles with a measurement function. These logistics vehicles will involve different algorithm modules.

For example, for a logistics vehicle, it may have an automatic sorting apparatus, and the automatic sorting apparatus may take out, transport, sort, and store cargos automatically after the logistics vehicle arrives at a destination. This will involve an algorithm module for sorting cargos. The algorithm module is mainly used for logic controls, such as taking out, transporting, sorting, and storing cargos, etc.

For another example, for cold chain logistics scenarios, the logistics vehicle may also have a refrigeration and heat preservation apparatus. The refrigeration and heat preservation apparatus may realize the refrigeration or heat preservation of transported fruits, vegetables, aquatic products, frozen foods, and other perishable foods, so that they are in a suitable temperature environment, and the problem of long-distance transportation for perishable foods is solved. This involves the algorithm module used for refrigeration and heat preservation control, and the algorithm module is mainly used for computing the suitable temperature for refrigeration or heat preservation according to information dynamics such as the nature, perishability, transportation time, current season, climate, etc. of foods (or goods), and automatically adjusting the refrigeration and heat preservation apparatus according to the suitable temperature. In this way, the transportation personnel do not need to manually adjust the temperature when the vehicle transports different foods or goods, which frees the transportation personnel from tedious temperature control, and improves the efficiency of transportation of refrigeration and heat preservation.

For another example, in most logistics scenarios, charges are based on the volume and/or weight of a package. While the number of logistics packages is very large, the efficiency of only relying on couriers to measure the volume and/or weight of the logistics packages is very low, and the labor costs are higher. Therefore, in some logistics vehicles, a measuring apparatus is added, which may automatically measure the volume and/or weight of a logistics package, and calculate the cost of the logistics package. This involves an algorithm module used for measuring a logistics package, and the algorithm module is used for identifying the type of a logistics package and determining a measurement method of the logistics package, such as volume measurement, weight measurement or a combination of volume measurement and weight measurement at the same time. In addition, the volume and/or weight measurement may be completed according to the determined measurement method, and cost calculation is completed according to the measurement result.

Herein, the public service vehicles refer to vehicles providing some kind of public services, for example, they may be fire trucks, deicing trucks, sprinkler trucks, snowplows, garbage disposal vehicles, traffic command vehicles, etc. These public service vehicles may involve different algorithm modules.

For example, for an autonomous fire truck, its main task is to carry out a reasonable fire extinguishing task for a fire scene, which involves an algorithm module used for the fire extinguishing task. The algorithm module at least requires logics such as identification of a fire condition, planning of a fire extinguishing scheme, automatic control of a fire extinguishing apparatus, etc.

For another example, for a deicing truck, its main task is to remove the ice and snow on a road surface, which involves an algorithm module used for deicing. The algorithm module at least requires logics such as realizing the identification of an ice and snow condition on the road surface, formulating a deicing scheme according to the ice and snow condition (such as, which road sections need to be deiced, which road sections do not need to be deiced, whether to use a spilling salt manner, the number of grams of salts to be spilled, etc.), and performing automatic control on a deicing apparatus in a case where the deicing scheme is determined, etc.

Herein, the medical service vehicles refer to autonomous vehicles which may provide one kind or multiple kinds of medical services. This kind of vehicle may provide medical services, such as disinfection, temperature measurement, dispensing, isolation, etc., which involves algorithm modules used for providing multiple kinds of self-service medical services. These algorithm modules are mainly used for realizing the identification of a disinfection requirement and controlling a disinfecting apparatus so that the disinfecting apparatus may disinfect a patient, or, identifying the position of a patient, and controlling a temperature measurement apparatus to automatically close the patient's forehead and other positions, to measure the temperature for the patient. Or, these algorithm modules are used for realizing the judgement of diseases, giving prescriptions according to the judgement result and needing to realize the identification of a medicine and a medicine container, and controlling a medicine taking manipulator, so that the medicine taking manipulator may grab the medicine for the patient according to the prescription, etc.

Herein, the terminal service vehicles refer to autonomous vehicles which may replace some terminal devices and provide some kind of convenient service to a user. For example, these vehicles may provide the user with services, such as printing, attendance, scanning, unlocking, payment, retail, etc.

For example, in some application scenarios, the user usually needs to arrive at a specific location to print or scan a document, which is time consuming and laborious. Therefore, a kind of terminal service vehicle which may provide printing/scanning services to a user appears. This service vehicle may be interconnected with a user terminal equipment. The user transmits a printing instruction by the terminal equipment, and the service vehicle automatically prints, in response to the printing instruction, a document required by the user, and may automatically deliver the printed document to the position where the user is located. Thus, the user does not need to queue up at the printer, which greatly improves printing efficiency. Or, the service vehicle may move, in response to a scanning instruction transmitted by a user through a terminal equipment, to the position where the user is located. The user places a document to be scanned on the scanning tool of the service vehicle, to complete scanning. Thus, the user does not need to queue up at the printer/scanner, thereby saving both time and labor. This involves an algorithm module providing printing/scanning services, and the algorithm module at least needs to identify the interconnection to a user terminal equipment, the response to printing/scanning instructions, the positioning of the user's position, travel control, etc.

For another example, with the development of new retailing scenarios, more and more e-commerce companies use self-service vending machines to sell goods at each major office building and public area. However, these self-service vending machines are placed at fixed positions, and may not be moved. A User needs to go to the self-service vending machine to purchase the required goods, thus the convenience is still poor. Therefore, autonomous vehicles which may provide a retail service appears. These service vehicles may carry goods and move autonomously, and may provide a corresponding self-service shopping APP or shopping portal. The user may place an order to the autonomous vehicle providing the retail service through an APP or shopping portal with the help of a terminal, such as a mobile phone, etc. The order contains the name, and quantity of goods to be purchased, and user position. After an order request is received, the vehicle may determine whether the current remaining goods have the goods purchased by the user and the quantity is sufficient. When it is determined that there are the goods purchased by the user and the quantity is sufficient, the vehicle may carry these goods and automatically move to the user position, and provide these goods to the user, which further improves the convenience of shopping for users, saves the user's time and enable the user to put time on more important things. This involves an algorithm module providing a retail service, and the algorithm module is mainly used for realizing logics such as responding to the user' order request, order processing, goods information maintenance, user position positioning, payment management, etc.

It is noted that the method in this embodiment may also include the method in the embodiments shown in FIG. 1 to FIG. 9, and the parts which are not described in detail in this embodiment may refer to the relevant explanation of the embodiments shown in FIG. 1 to FIG. 9. The performing process and technical effects of this technical solution refer to the description of the embodiments shown in FIG. 1 to FIG. 9, which are not further elaborated herein.

FIG. 11 is a schematic flow chart of a radio frequency communication method provided by an embodiment of the present application. Referring to FIG. 11, this embodiment provides a radio frequency communication method, and the execution body of this method may be a radio frequency apparatus. Herein, the radio frequency apparatus may be applied to cloud XR scenarios or cloud computing scenarios, etc., and the radio frequency apparatus may be implemented in software, or a combination of software and hardware. Specifically, the radio frequency communication method of this embodiment may include:

Step S1101: acquiring a first response signal and a second response signal which are corresponding to a radio frequency tag in an extended reality terminal, wherein the first response signal and the second response signal are respectively generated by the radio frequency tag responding to radio frequency signals of different powers.

The extended reality terminal may be implemented as a headset mount device (abbreviated as HMD) based on the field of augmented reality (abbreviated as AR), virtual reality (abbreviated as VR), or mixed reality/hybrid reality (abbreviated as MR/HR), or cinematic reality (abbreviated as CR). The extended reality terminal may communicate with a cloud platform, to realize an extended reality game scene, an extended reality meeting scene, etc. based on the extended reality terminal.

Step S1102: determining, based on the second response signal, positioning information of the extended reality terminal.

Step S1103: establishing, based on the positioning information and the first response signal, a communication connection to the extended reality terminal.

The specific implementations and implementation effects of Step S1101 to Step 1103 are similar to the specific implementations and implementation effects of Step S201 to Step 203. Details may be obtained by referring to the content stated above and will not be further elaborated herein.

In some other embodiments, after the communication connection to the extended reality terminal is established based on the positioning information and the first response signal, the virtual scene information in the extended reality terminal may be acquired, and the displaying positioning information of a preset object of an extended reality terminal in the virtual scene information is determined. The movable range of the extended reality terminal in an actual area is determined based on the positioning information of the extended reality terminal, and a mapping relationship between the movable range and the virtual movable area of the preset object in the virtual scene information is established, which may effectively avoid the collision with the actual scene when the user uses the extended reality terminal, thereby improving the experience of the user in using the extended reality terminal.

It is noted that the method of this embodiment may also include the method of the embodiments shown in FIG. 1 to FIG. 9 and the parts which are not described in detail in this embodiment may refer to the relevant explanation of the embodiments shown in FIG. 1 to FIG. 9. The performing process and technical effects of this technical solution refer to the description of the embodiments shown in FIG. 1 to FIG. 9, which is not further elaborated herein.

Similar to the above implementation, the extended reality terminal may be implemented as a conference equipment, and the conference equipment includes a radio frequency tag. At this time, the radio frequency communication method of this embodiment may include:

Step S1101: acquiring a first response signal and a second response signal which are corresponding to a radio frequency tag in a conference equipment, wherein the first response signal and the second response signal are respectively generated by the radio frequency tag responding to radio frequency signals of different powers.

The conference equipment may be implemented as a handheld device, a conference card, etc., which include a radio frequency chip.

Step S1102: determining, based on the second response signal, positioning information of the conference equipment.

Step S1103: establishing, based on the positioning information and the first response signal, a communication connection to the conference equipment.

The specific implementations and implementation effects of Step S1101 to Step 1103 are similar to the specific implementations and implementation effects of Step S201 to Step 203. Details may be obtained by referring to the content stated above, and will not be further elaborated herein.

In some other embodiments, after the communication connection to the conference equipment is established based on the positioning information and the first response signal, the identification of each conference participant attending the conference may be determined based on the conference equipment which establishes the communication connection, so that the check in operation and the identification operation of conference participants may be quickly determined, and the practicality of this method is further improved.

It is noted that the method of this embodiment may also include the method of the embodiments shown in FIG. 1 to FIG. 9 and the parts which are not described in detail in this embodiment may refer to the relevant explanation of the embodiments shown in FIG. 1 to FIG. 9. The performing process and technical effects of this technical solution refer to the description of the embodiments shown in FIG. 1 to FIG. 9, which is not further elaborated herein.

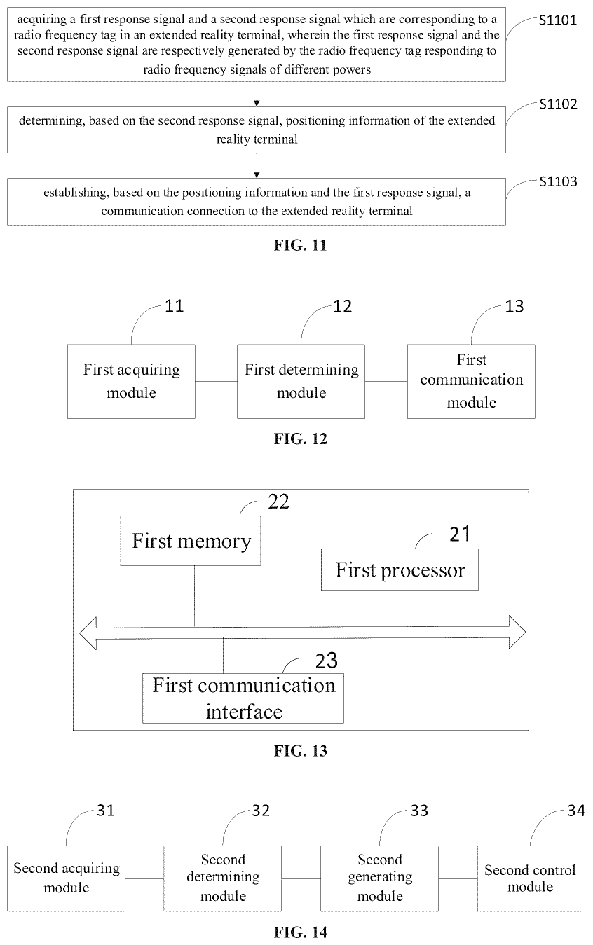

FIG. 12 is a schematic structural diagram of a radio frequency communication apparatus provided by an embodiment of the present application. Referring to FIG. 12, this embodiment provides a radio frequency communication apparatus, and the radio frequency communication apparatus is used for performing the foregoing radio frequency communication method shown in FIG. 2. Specifically, the radio frequency communication apparatus may include:
a first acquiring module 11, configured for acquiring a first response signal and a second response signal which are corresponding to a radio frequency tag, wherein the first response signal and the second response signal are respectively generated by the radio frequency tag responding to radio frequency signals of different powers;
a first determining module 12, configured for determining, based on the second response signal, positioning information of the radio frequency tag; and
a first communication module 13, configured for establishing, based on the positioning information and the first response signal, a communication connection to the radio frequency tag.

In some embodiments, when the first acquiring module 11 acquires the first response signal corresponding to the radio frequency tag, the first acquiring module 11 is configured for performing: transmitting, by a first signal reader, a first radio frequency signal to the radio frequency tag; and receiving, by the first signal reader, the first response signal corresponding to the radio frequency tag, wherein the first response signal is generated by the radio frequency tag reflecting the first radio frequency signal.

In some embodiments, when the first acquiring module 11 acquires the second response signal corresponding to the radio frequency tag, the first acquiring module 11 is configured for performing: transmitting, by a second signal reader, a second radio frequency signal to the radio frequency tag, wherein a power of the second radio frequency signal is less than a power of the first radio frequency signal, and the power of the second radio frequency signal is less than or equal to a preset threshold; and acquiring, by the second signal reader, the second response signal corresponding to the radio frequency tag, wherein the second response signal is generated by the radio frequency tag reflecting the second radio frequency signal.

In some embodiments, when the first acquiring module 11 transmits, through the second signal reader, the second radio frequency signal to the radio frequency tag, the first acquiring module 11 is configured for performing: generating, by the second signal reader, multiple narrowband subcarriers of different frequencies; and integrating the multiple narrowband subcarriers of different frequencies, to obtain the second radio frequency signal.

In some embodiments, when the first acquiring module 11 determines, based on the second response signal, the positioning information of the radio frequency tag, the first acquiring module 11 is configured for performing: acquiring area information corresponding to the radio frequency tag; performing channelization processing on the second response signal, to obtain digital sampling information corresponding to respective frequency point of multiple frequency points; determining, based on the digital sampling information corresponding to respective frequency point of the multiple frequency points, channel estimation information corresponding to the second response signal; and determining, based on the channel estimation information and the area information, the positioning information of the radio frequency tag.

In some embodiments, when the first acquiring module 11 determines, based on the digital sampling information corresponding to respective frequency point of the multiple frequency points, the channel estimation information corresponding to the second response signal, the first acquiring module 11 is configured for performing: acquiring preamble information in the digital sampling information corresponding to respective frequency point of the multiple frequency points; determining, based on the preamble information, initial start time and initial frequency offset information which are corresponding to respective frequency point of the multiple frequency points; and determining, based on the initial start time and the initial frequency offset information which are corresponding to respective frequency point of the multiple frequency points, the channel estimation information corresponding to the second response signal.

In some embodiments, when the first acquiring module 11 determines, based on the initial start time and the initial frequency offset information which are corresponding to respective frequency point of the multiple frequency points, the channel estimation information corresponding to the second response signal, the first acquiring module 11 is configured for performing: performing processing on the second response signal by using an edge extraction technique and a digital phase locked loop, and in combination with the initial start time and the initial frequency offset information, to obtain target start time and target frequency offset information; and performing non-uniform time sampling and interpolation processing on the target start time and the target frequency offset information, to obtain the channel estimation information corresponding to the second response signal.

In some embodiments, after the initial start time and the initial frequency offset information which are corresponding to respective frequency point of the multiple frequency points are determined, the first determining module 12 is configured for performing the following steps: determining a jump parameter used for adjusting the channel estimation information; and in the process of performing processing on the second response signal by using an edge extraction technique and a digital phase locked loop, and in combination with the initial start time and the initial frequency offset information, adjusting the channel estimation information by using the jump parameter, to obtain target channel estimation, wherein there is not a phase jump of π in target start time corresponding to the target channel estimation.

In some embodiments, when the first acquiring module 11 determines, based on the channel estimation information and the area information, the positioning information of the radio frequency tag, the first acquiring module 11 is configured for performing: determining, based on the channel estimation information, phase information corresponding to respective frequency point of the multiple frequency points; and determining, based on the phase information corresponding to respective frequency point of the multiple frequency points and the area information, the positioning information of the radio frequency tag.

In some embodiments, when the first acquiring module 11 determines, based on the phase information corresponding to respective frequency point of the multiple frequency points and the area information, the positioning information of the radio frequency tag, the first acquiring module 11 is configured for performing: acquiring estimated phase information corresponding to respective position areas in the area information; determining, based on the phase information corresponding to respective frequency point of the multiple frequency points and the estimated phase information, initial positioning information of respective frequency point of the multiple frequency points; and determining, based on the initial positioning information corresponding to all frequency points and the phase information corresponding to all frequency points, the positioning information of the radio frequency tag.

In some embodiments, when the first acquiring module 11 determines, based on the phase information corresponding to each frequency point and the estimated phase information, initial positioning information of each frequency point, the first acquiring module 11 is configured for performing: acquiring a similarity between the phase information of each frequency point and the estimated phase information corresponding to each position area; and determining, based on the similarity, initial positioning information of each frequency point.

In some embodiments, when the first acquiring module 11 determines, based on initial positioning information of all frequency points and phase information of all frequency points, the positioning information of the radio frequency tag, the first acquiring module 11 is configured for performing: determining, based on the initial positioning information of all frequency points and the phase information of all frequency points, probability information that the radio frequency tag is located in each position area; determining, based on the probability information, a target position area corresponding to a maximum probability; and determining, based on the target position area, positioning information of the radio frequency tag.

The radio frequency apparatus shown in FIG. 12 may perform the methods of the embodiments shown in FIG. 1 to FIG. 9 and the parts which are not described in detail in this embodiment can refer to the relevant explanation of the embodiments shown in FIG. 1 to FIG. 9. The performing process and technical effects of this technical solution refer to the description of the embodiments shown in FIG. 1 to FIG. 9, which is not further elaborated herein.

In a possible design, the structure of the radio frequency communication apparatus shown in FIG. 12 may be implemented as an electronic device, and the electronic device may be a network controller, etc. As shown in FIG. 13, the electronic device may include a first processor 21 and a first memory 22. The first memory 22 is configured for storing a program corresponding to the electronic device performing the radio frequency communication method provided in the foregoing embodiments shown in FIG. 1 to FIG. 9, and the first processor 21 is configured for executing the program stored in the first memory 22.

The program includes one or more computer instructions, and the one or more computer instructions, when executed by the first processor 21, may realize the following steps: acquiring a first response signal and a second response signal which are corresponding to a radio frequency tag, wherein the first response signal and the second response signal are respectively generated by the radio frequency tag responding to radio frequency signals of different powers; determining, based on the second response signal, positioning information of the radio frequency tag; and establishing, based on the positioning information and the first response signal, a communication connection to the radio frequency tag.

Further, the first processor 21 is further configured for performing all/part steps of the foregoing embodiments in FIG. 1 to FIG. 9.

The structure of the electronic device may also include a first communication interface 23 configured for the electronic device to communicate with other devices or communication networks.

In addition, the embodiments of the present application provide a computer storage medium for storing computer software instructions used by an electronic device, which includes a program for performing the radio frequency communication method in the method embodiments shown in FIG. 1 to FIG. 9.

In addition, the embodiments of the present application provide a computer program product, including: a computer program, and the computer program, when executed by a processor of an electronic device, causes the processor to execute the radio frequency communication method in the method embodiments shown in FIG. 1 to FIG. 9.

FIG. 14 is a schematic structural diagram of a vehicle control apparatus provided by an embodiment of the present application. Referring to FIG. 14, this embodiment provides a vehicle control apparatus, and the vehicle control apparatus is configured for performing the foregoing vehicle control method shown in FIG. 10. Specifically, the vehicle control apparatus may include:
a second acquiring module 31, configured for acquiring a first response signal and a second response signal, which are corresponding to a radio frequency tag in a vehicle to be controlled, wherein the first response signal and the second response signal are respectively generated by the radio frequency tag responding to radio frequency signals of different powers;
a second determining module 32, configured for determining, based on the second response signal, positioning information of the vehicle to be controlled;
a second generating module 33, configured for generating, based on the positioning information and the first response signal, control information corresponding to the vehicle to be controlled; and
a second control module 34, configured for controlling, based on the control information, the vehicle to be controlled.

The vehicle control apparatus shown in FIG. 14 may perform the method of the embodiment shown in FIG. 10, and the parts which are not described in detail in this embodiment may refer to the relevant explanation of the embodiment shown in FIG. 10. The performing process and technical effects of this technical solution refer to the description of the embodiment shown in FIG. 10, which are not further elaborated herein.

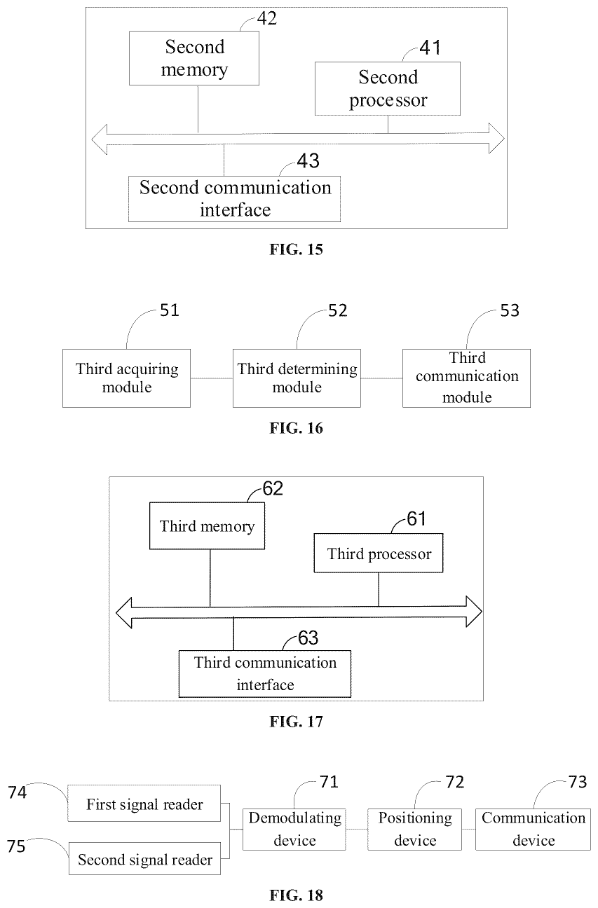

In a possible design, the structure of the vehicle control apparatus shown in FIG. 14 may be implemented as an electronic device. As shown in FIG. 15, the electronic device may include a second processor 41 and a second memory 42. The second memory 42 is configured for storing a program corresponding to the electronic device performing the vehicle control method provided in the foregoing embodiment shown in FIG. 10, and the second processor 41 is configured for executing the program stored in the second memory 42.

The program includes one or more computer instructions, and the one or more computer instructions, when executed by the second processor 41, may realize the following steps: acquiring a first response signal and a second response signal, which are corresponding to a radio frequency tag in a vehicle to be controlled, wherein the first response signal and the second response signal are respectively generated by the radio frequency tag responding to radio frequency signals of different powers; determining, based on the second response signal, positioning information of the vehicle to be controlled; generating, based on the positioning information and the first response signal, control information corresponding to the vehicle to be controlled; and controlling, based on the control information, the vehicle to be controlled.

Further, the second processor 41 is further configured for performing all/part steps of the foregoing embodiment in FIG. 10. The structure of the electronic device may further include a second communication interface 43 configured for the electronic device to communicate with other devices or communication networks.

In addition, the embodiments of the present application provide a computer storage medium for storing computer software instructions used by the electronic device, which includes a program for executing the vehicle control method in the method embodiment shown in FIG. 10.

In addition, the embodiments of the present application provide a computer program product, including: a computer program, and the computer program, when executed by a processor of the electronic device, causes the processor to execute the vehicle control method in the method embodiment shown in FIG. 10.

FIG. 16 is a schematic structural diagram of a radio frequency communication apparatus provided by an embodiment of the present application. Referring to FIG. 16, this embodiment provides a radio frequency apparatus, and the radio frequency apparatus is configured for performing the foregoing radio frequency communication method shown in FIG. 11. Specifically, the radio frequency apparatus may include:
a third acquiring module 51, configured for acquiring a first response signal and a second response signal which are corresponding to a radio frequency tag in an extended reality terminal, wherein the first response signal and the second response signal are respectively generated by the radio frequency tag responding to radio frequency signals of different powers;
a third determining module 52, configured for determining, based on the second response signal, positioning information of the extended reality terminal; and
a third communication module 53, configured for establishing, based on the positioning information and the first response signal, a communication connection to the extended reality terminal.

The radio frequency apparatus shown in FIG. 16 may perform the method of the embodiment shown in FIG. 11, and the parts which are not described in detail in this embodiment may refer to the relevant explanation of the embodiment shown in FIG. 11. The performing process and technical effects of this technical solution refer to the description of the embodiment shown in FIG. 11, which are not further elaborated herein.

In a possible design, the structure of the radio frequency apparatus shown in FIG. 16 may be implemented as an electronic device. As shown in FIG. 17, the electronic device may include a third processor 61 and a third memory 62. The third memory 62 is configured for storing a program corresponding to the electronic device performing the radio frequency communication method provided in the foregoing embodiment shown in FIG. 11, and the third processor 61 is configured for executing the program stored in the third memory 62.

The program includes one or more computer instructions, and the one or more computer instructions, when executed by the second processor 41, may realize the following steps: acquiring a first response signal and a second response signal which are corresponding to a radio frequency tag in an extended reality terminal, wherein the first response signal and the second response signal are respectively generated by the radio frequency tag responding to radio frequency signals of different powers; determining, based on the second response signal, positioning information of the extended reality terminal; and establishing, based on the positioning information and the first response signal, a communication connection to the extended reality terminal.

Further, the third processor 61 is further configured for performing all/part steps in the foregoing embodiment in FIG. 11. The structure of the electronic device may further include a third communication interface 63 configured for the electronic device to communicate with other devices or communication networks.

In addition, the embodiments of the present application provide a computer storage medium for storing computer software instructions used by the electronic device, which includes a program for executing the radio frequency communication method in the method embodiment shown in FIG. 11.

In addition, the embodiments of the present application provide a computer program product, including: a computer program, and the computer program, when executed by a processor of the electronic device, causes the processor to execute the radio frequency communication method in the method embodiment shown in FIG. 11.

FIG. 18 is a schematic structural diagram of a radio frequency communication system provided by an embodiment of the present application. Referring to FIG. 18, this embodiment provides a radio frequency communication system, and the radio frequency communication system may include:
a demodulating device 71, configured for acquiring a first response signal and a second response signal which are corresponding to a radio frequency tag, wherein the first response signal and the second response signal are respectively generated by the radio frequency tag responding to radio frequency signals of different powers;
a positioning device 72, configured for determining, based on the second response signal, positioning information of the radio frequency tag; and
a communication device 73, configured for establishing, based on the positioning information and the first response signal, a communication connection to the radio frequency tag.

In some embodiments, the system in this embodiment further includes a first signal reader 74, and the first signal reader 74 is configured for: transmitting a first radio frequency signal to the radio frequency tag; and receiving the first response signal corresponding to the radio frequency tag, and transmitting the first response signal to the demodulating device, wherein the first response signal is generated by the radio frequency tag reflecting the first radio frequency signal.

In some other embodiments, the system in this embodiment further includes a second signal reader 75, and the second signal reader 75 is configured for: transmitting a second radio frequency signal to the radio frequency tag, wherein a power of the second radio frequency signal is less than a power of the first radio frequency signal and the power of the second radio frequency signal is less than or equal to a preset threshold; and receiving the second response signal corresponding to the radio frequency tag, and transmitting the second response signal to the demodulating device, wherein the second response signal is generated by the radio frequency tag reflecting the second radio frequency signal.

Specifically, the specific implementations and implementation effects of the demodulating device 71 and the positioning device 72 in this embodiment are similar to the foregoing specific implementations and implementation effects of the radio frequency communication methods shown in FIG. 1 to FIG. 10. Details may be obtained by referring to the content stated above, and will not be further elaborated herein.

The apparatus embodiments described above are merely illustrative, the units described as separate components may or may not be physically separate, and the components displayed as units may or may not be physical units, that is, they may be located at the same place, or they may be distributed to multiple network units. Some or all of the modules may be selected according to actual needs, to achieve the purpose of the solution of the embodiment. It can be understood and implemented by those ordinary skilled in the art without any creative efforts.

Through the description of the above embodiments, those skilled in the art may clearly understand that the embodiments may be implemented by a required general hardware platform, and certainly may also be implemented by a combination of hardware and software. Based on such understanding, the essence of the technical solutions or the part that contributes to the prior art may be embodied in the form of a computer product. The present application may use the form of a computer program product implemented on one or multiple computer-usable storage media (including, but not limited to, a magnetic disk memory, a CD-ROM, an optical memory, etc.) containing computer-usable program codes therein.

The present application is described with reference to flowcharts and/or block diagrams of a method, a device (system), and a computer program product according to the embodiments of the present application. It should be understood that each procedure and/or block in the flowcharts and/or block diagrams, and a combination of procedures and/or blocks in the flowcharts and/or block diagrams may be implemented with computer program instructions. These computer program instructions may be provided to a processor of a general-purpose computer, a special-purpose computer, an embedded processor, or any other programmable device to produce a machine, so that instructions executed by the processor of the computer or other programmable devices generate an apparatus for implementing a specified function in one or multiple procedures in the flowcharts and/or one or multiple blocks in the block diagrams.

These computer program instructions may also be stored in a computer-readable memory that may direct a computer or any other programmable device to operate in a particular manner, such that the instructions stored in the computer-readable memory produce an article of manufacture including instruction means, the instruction means implement a specified function in one or multiple procedures in the flowcharts and/or one or multiple blocks in the block diagrams. These computer program instructions may also be loaded into a computer or any other programmable device so that a series of operational steps are performed on the computer or other programmable devices to produce computer-implemented processing, and thus the instructions executed on the computer or other programmable device provide the steps for implementing a specified function in one or multiple procedures in the flowcharts and/or one or multiple blocks in the block diagrams.

In a typical configuration, the computing device includes one or multiple processors (CPUs), an input/output interface, a network interface, and a memory. The memory may include a computer-readable medium in the form of non-permanent memory, random access memory (RAM) and/or non-volatile memory or the like, such as read-only memory (ROM) or flash memory (flash RAM). The memory is an example of a computer-readable medium.

The computer-readable medium includes permanent and non-permanent, movable and non-movable media that may achieve information storage by means of any methods or techniques. The information may be computer-readable instructions, data structures, modules of programs or other data. Examples of a storage medium of a computer include, but are not limited to, a phase change memory (PRAM), a static random access memory (SRAM), a dynamic random access memory (DRAM), other types of random access memories (RAMs), a read-only memory (ROM), an electrically erasable programmable read-only memory (EEPROM), a flash memory or other memory technologies, a compact disk read-only memory (CD-ROM), a digital versatile disc (DVD) or other optical storages, a cassette tape, a magnetic tape/magnetic disk storage or other magnetic storage devices, or any other non-transmission medium, and may be used to store information accessible by a computing device. According to the definitions herein, the computer-readable medium does not include transitory computer-readable media (transitory media), such as modulated data signals and carriers.

It should be finally noted that the above embodiments are merely used for illustrating rather than limiting the technical solutions of the present application. Although the present application is described in detail with reference to the foregoing embodiments, those ordinary skill in the art should understand that the technical solutions disclosed in the foregoing embodiments may still be modified or equivalent replacement may be made on part or all of the technical features therein. These modifications or replacements will not make the essence of the corresponding technical solutions be departed from the spirit and scope of the technical solutions in the embodiments of the present application.

What is claimed is:

1. A radio frequency communication method, comprising:
acquiring a first response signal and a second response signal which are corresponding to a radio frequency tag, wherein the first response signal and the second response signal are respectively generated by the radio frequency tag responding to radio frequency signals of different powers;
determining, based on the second response signal, positioning information of the radio frequency tag; and
establishing, based on the positioning information and the first response signal, a communication connection to the radio frequency tag.

2. The method according to claim 1, wherein the acquiring the first response signal corresponding to the radio frequency tag, comprises:
transmitting, by a first signal reader, a first radio frequency signal to the radio frequency tag; and
receiving, by the first signal reader, the first response signal corresponding to the radio frequency tag, wherein the first response signal is generated by the radio frequency tag reflecting the first radio frequency signal.

3. The method according to claim 2, wherein the acquiring the second response signal corresponding to the radio frequency tag, comprises:
transmitting, by a second signal reader, a second radio frequency signal to the radio frequency tag, wherein a power of the second radio frequency signal is less than a power of the first radio frequency signal, and the power of the second radio frequency signal is less than or equal to a preset threshold; and
acquiring, by the second signal reader, the second response signal corresponding to the radio frequency tag, wherein the second response signal is generated by the radio frequency tag reflecting the second radio frequency signal.

4. The method according to claim 3, wherein the transmitting, by the second signal reader, the second radio frequency signal to the radio frequency tag, comprises:
generating, by the second signal reader, a plurality of narrowband subcarriers of different frequencies; and
integrating the plurality of narrowband subcarriers of different frequencies, to obtain the second radio frequency signal.

5. The method according to claim 1, wherein the determining, based on the second response signal, the positioning information of the radio frequency tag, comprises:
acquiring area information corresponding to the radio frequency tag;
performing channelization processing on the second response signal, to obtain digital sampling information corresponding to respective frequency point of a plurality of frequency points;
determining, based on the digital sampling information corresponding to respective frequency point of the plurality of frequency points, channel estimation information corresponding to the second response signal; and
determining, based on the channel estimation information and the area information, the positioning information of the radio frequency tag.

6. The method according to claim 5, wherein the determining, based on the digital sampling information corresponding to the respective frequency point of the plurality of frequency points, the channel estimation information corresponding to the second response signal, comprises:
acquiring preamble information in the digital sampling information corresponding to respective frequency point of the plurality of frequency points;
determining, based on the preamble information, initial start time and initial frequency offset information which are corresponding to respective frequency point of the plurality of frequency points; and
determining, based on the initial start time and the initial frequency offset information which are corresponding to respective frequency point of the plurality of frequency points, the channel estimation information corresponding to the second response signal.

7. The method according to claim 6, wherein the determining, based on the initial start time and the initial frequency offset information which are corresponding to respective frequency point of the plurality of frequency points, the channel estimation information corresponding to the second response signal, comprises:
performing processing on the second response signal by using an edge extraction technique and a digital phase locked loop, and in combination with the initial start time and the initial frequency offset information, to obtain a target start time and target frequency offset information; and
performing non-uniform time sampling and interpolation processing on the target start time and the target frequency offset information, to obtain the channel estimation information corresponding to the second response signal.

8. The method according to claim 5, wherein the determining, based on the channel estimation information and the area information, the positioning information of the radio frequency tag, comprises:
determining, based on the channel estimation information, phase information corresponding to respective frequency point of the plurality of frequency points; and
determining, based on the phase information corresponding to respective frequency point of the plurality of frequency points and the area information, the positioning information of the radio frequency tag.

9. The method according to claim 8, wherein the determining, based on the phase information corresponding to respective frequency point of the plurality of frequency points and the area information, the positioning information of the radio frequency tag, comprises:
acquiring estimated phase information corresponding to respective position areas in the area information;
determining, based on the phase information corresponding to respective frequency point of the plurality of frequency points and the estimated phase information, initial positioning information of respective frequency point of the plurality of frequency points; and
determining, based on the initial positioning information corresponding to all frequency points and the phase information corresponding to all frequency points, the positioning information of the radio frequency tag.

10. A vehicle control method, comprising:
acquiring a first response signal and a second response signal, which are corresponding to a radio frequency tag in a vehicle to be controlled, wherein the first response signal and the second response signal are respectively generated by the radio frequency tag responding to radio frequency signals of different powers;
determining, based on the second response signal, positioning information of the vehicle to be controlled;
generating, based on the positioning information and the first response signal, control information corresponding to the vehicle to be controlled; and
controlling, based on the control information, the vehicle to be controlled.

11. An electronic device, comprising: a memory and a processor; wherein the memory is configured for storing one or more computer instructions, and the one or more computer instructions, when executed by the processor, implement the radio frequency communication method according to claim 1.

12. A radio frequency communication system, comprising:
a demodulating device, configured for acquiring a first response signal and a second response signal which are corresponding to a radio frequency tag, wherein the first response signal and the second response signal are respectively generated by the radio frequency tag responding to radio frequency signals of different powers;
a positioning device, configured for determining, based on the second response signal, positioning information of the radio frequency tag; and
a communication device, configured for establishing, based on the positioning information and the first response signal, a communication connection to the radio frequency tag.

13. The system according to claim 12, further comprising: a first signal reader, wherein the first signal reader is configured for:
transmitting a first radio frequency signal to the radio frequency tag; and
receiving the first response signal corresponding to the radio frequency tag, and transmitting the first response signal to the demodulating device, wherein the first response signal is generated by the radio frequency tag reflecting the first radio frequency signal.

14. The system according to claim 13, further comprising: a second signal reader, wherein the second signal reader is configured for:
transmitting a second radio frequency signal to the radio frequency tag, wherein a power of the second radio frequency signal is less than a power of the first radio frequency signal, and the power of the second radio frequency signal is less than or equal to a preset threshold; and
receiving the second response signal corresponding to the radio frequency tag, and transmitting the second response signal to the demodulating device, wherein the second response signal is generated by the radio frequency tag reflecting the second radio frequency signal.

15. A computer-readable storage medium storing a computer program, wherein the computer program, when executed by a computer, implements the method according to claim 1.

16. A computer-readable storage medium storing a computer program, wherein the computer program, when executed by a computer, implements the method according to claim 10.

17. An electronic device, comprising: a memory and a processor; wherein the memory is configured for storing one or more computer instructions, and the one or more computer instructions, when executed by the processor, implement the radio frequency communication method according to claim 2.

18. An electronic device, comprising: a memory and a processor; wherein the memory is configured for storing one or more computer instructions, and the one or more computer instructions, when executed by the processor, implement the radio frequency communication method according to claim 3.

19. An electronic device, comprising: a memory and a processor; wherein the memory is configured for storing one or more computer instructions, and the one or more computer instructions, when executed by the processor, implement the radio frequency communication method according to claim 4.

20. An electronic device, comprising: a memory and a processor; wherein the memory is configured for storing one or more computer instructions, and the one or more computer instructions, when executed by the processor, implement the radio frequency communication method according to claim 5.
